(19) United States
(12) Patent Application Publication
(10) Pub. No.: US 2010/0231378 A1
(43) Pub. Date: Sep. 16, 2010

(54) Personal Security System

(76) Inventor: Linda Rosita Ward, Fort Washington, MD (US)

Correspondence Address: GREENBERG & LIEBERMAN, LLC, 2141 WISCONSIN AVE, N.W., SUITE C-2, WASHINGTON, DC, 20007, US

(21) Appl. No.: 12/485,906

(22) Filed: Jun. 16, 2009

Related U.S. Application Data
(60) Provisional application No. 61/132,506, filed on Jun. 16, 2008.

(51) Int. Cl. G08B 1/08

(52) U.S. Cl. 340/539.11

(57) ABSTRACT

A personal security system relating to a method of applying remote access to track, gather data and receive alerts from a distant personal accessory such as a bracelet or watch. An alert signal is emitted during a number of scenarios including dramatic changes to adrenaline, traveling to a certain distance threshold, or tampering or attempted removal of the personal accessory. In addition, the alert can only be canceled by the authorized receiver.

### CONTINUITY DATA

This is a non-provisional patent application of provisional patent application No. 61/132,506 filed on Jun. 16, 2008, and priority is claimed thereto.

### FIELD OF THE PRESENT INVENTION

The present invention is a personal security system relating to a method of applying remote access to track and gather data from a distant accessory in addition to a method of requiring a signal to be emitted if the accessory is removed without remote authorization.

### BACKGROUND OF THE PRESENT INVENTION

In the United States alone every year statistic show that about 90,000 forcible rapes, 17,000 murder, 800,000 aggravated assaults and 200,000 cases of child abductions occur. Half of the abducted children in the United States are sexually abused and most of them are teenage girls. It is difficult for citizens, residents, parents and law enforcement to witness such injustice to humans and children in particular. In addition, a large number of abductions remain unsolved while every year thousands of children become victims of crime—whether it's kidnappings, violent attacks or sexual abuse. Whenever the evening news brings the story of a kidnapped child or teen, the terrifying prospect of abduction fills the minds of parents across the country. One of the challenges of being a parent is to teach their children to be cautious without filling them with fear or anxiety. A number of items exist to assist parents in protecting and even tracking their children. For example, in the U.S., an existing child protection system commonly known as “Amber Alert” notifies the public through electronic signs on highways as well as on television in the vicinity of the abduction. However, this system fails to locate the child to intervene in real time. As such, there is a need for a system that uses global positioning elements in combination with state of the art alert process and tamper proof assemblage. The present invention solves this need by providing an non-cumbersome clothing accessory fitted with such tracking elements while also providing a means to alert proper users upon any attempts to either remove the accessory or harm the person or child.

Some Facts:

Most children who are reported missing have run away or there has been a misunderstanding with their parents about where they were supposed to be.

Of the children and teens who are truly abducted, most are taken by a family member or an acquaintance; 25% of children are taken by strangers.

Almost all children kidnapped by strangers are taken by men, and about two thirds of stranger abductions involve female children.

Most abducted children are in their teens.

Children are rarely abducted from school grounds.

In addition to the aforementioned facts, it also should be noted that law enforcement doctrine states that there is a limited window of time immediately after an abduction to safely recover a victim. The system of the present invention provides a means to quickly identify a victim through an array of tracking elements and alerts. It also is important to note that the system of the present invention solves this need by offering the additional safeguard of emitting an alert if the tracking element of the present invention immediately demonstrates evidence of being tampered.

US Patent Application 2005/0258958 filed on May 18, 2004 by Lai is a personal locator transmitter apparatus. Lai disguises GPS or other triangulation items within common child belongings. Unlike the present invention, Lai only is effective when an adult or law enforcement is made aware of a lost child. In contrast, the present invention permits the child to activate the alert in a manner that immediately notifies others. In addition, tampering also will cause an alert to immediately be emitted.

US Patent Application 2003/0176785 filed on Feb. 4, 2003 by Buckman et al is a method and apparatus for emergency patient tracking. Unlike the present invention, Buckman focuses on transmitting coded information into a central database for data management purposes. Buckman and other similar items do not offer immediate alerts and physical tracking.

US Patent Application 2006/0125620 filed on Jun. 15, 2006 by Smith et al is a monitoring and security system and method. Smith uses two-way communication for assistance in regard to vehicular issues via a hand-held wireless device and a remote call center, as well as tracking. Unlike the present invention, Smith does not emit an alert when there is an attempt to remove or tamper with the tracking element. In addition, the present invention is such that the alert cannot be removed until an authorized remote user physically acts to end the alert. This aspect is true no matter how the alert as initiated.

US Patent Application 2008/0001764 filed on Jan. 3, 2008 by Douglas et al is a personal crime prevention bracelet. Douglas is essentially a GPS tracking device located within a bracelet. There are numerous other items out there that seek to essentially perform the same function in regard to tracking. Unlike the present invention, Douglas and other like items does not emit an alert when there is an attempt to remove or tamper with the tracking element. In addition, the present invention is such that the alert cannot be removed until an authorized remote user physically acts to end the alert. This aspect is true no matter how the alert as initiated.

The issue of tracking through the use of conventional avenues is certainly known. This is due to the enormous efforts to protect children and other vulnerable people. However, there remains a need for a system that does more than merely track a person. The present invention solves this need by invoking a system where an immediate alert is emitted in regard to an actual or perceived danger. In addition, the present invention provides a user operating remotely to take expanded control over an alert in real time.

### SUMMARY OF THE PRESENT INVENTION

The present invention is a system that permits a user to monitor and track the location and condition of a second person. The present invention may apply to a parent-child relationship or any other scenario where tracking and monitoring is desired. A conventional remote control device is linked with a clothing accessory or some other item such as a briefcase. The user can place and lock the accessory onto the second person. This could be a bracelet or necklace clasp. Activation of GPS or other conventional tracking commences. The signal being emitted from the accessory in the preferred embodiment will be received via a conventional computing device or tracking element. If the accessory is removed or its internal components are disturbed, it will be akin to a separate circuit being opened. As such, the loss of the signal will trigger a notification to the computing device or remote control device. This subsequent alert will notify the user that the tracking device contained within the accessory has been removed.

In an additional embodiment of the present invention, a button or switch will be contained within the accessory. A person can compress the button or otherwise activate the switch. This button serves as a “panic button” to alert the holder of the remote control device or other computing device. In addition, an alert also may be emitted from a speaker device located within the accessory. The alerts will continue until the user stops the alert sound via the remote control device.

Existing child protection system notifies the public through electronic signs on highways (Amber Alert) in the vicinity of the abduction but this system fails to locate the child to intervene in time before the worst. However our device introduces the use of global positioning system in combination with state of the art alert systems and tamper proof assemblage.

### BRIEF DESCRIPTION OF DRAWINGS

FIG. 1 shows the cellular network evolution paths of current technologies to 2.5G and 3G.

FIG. 2 presents GPRS architecture.

FIG. 3 shows the package outline for the 56F8023.

FIG. 4 shows the mechanical parameters for the 56F8023.

FIGS. 5 and 6 presents the flow chart of the principle of alarm system operation.

FIGS. 7 and 8 shows the mechanical design of the bracelet.

FIG. 9 presents the design of the bracelet parts.

FIG. 10 shows the housing for devices.

FIG. 11 shows the front view of housing for devices.

FIG. 12 shows the top view of housing for devices.

FIG. 13 presents front view of pin.

FIG. 14 shows the top view of pin.

FIG. 15 shows the pulling sensor.

FIG. 16 presents the linear variable differential transformer.

FIGS. 17 and 18 show the spring.

FIG. 19 shows the top view of the spring.

FIG. 20 shows the front view of the spring.

FIG. 21 shows the top view of the small pins.

FIG. 22 shows the front view of the small pins.

FIG. 23 shows the connector.

FIG. 24 shows the front view of the connector.

FIG. 25 shows the top view of the connector.

FIG. 26 presents the left view of the connector.

FIG. 27 shows the operational amplifier.

FIG. 28 presents the electric diode.

FIG. 29 shows a flow chart of the input voltage.

FIG. 30 shows the two sets of teeth locked.

FIG. 31 shows the magnet, spring, magnet and teeth.

FIG. 32 presents the interior and exterior of bracelet.

FIGS. 33 through 46 show mechanical parts of bracelet.

FIG. 47 presents the cutting sensor.

FIGS. 48 and 49 show the entire bracelet.

FIG. 50 presents a pure titanium ring.

FIG. 51 presents pulling a bracelet.

FIG. 52 presents stresses across a section of the bracelet.

FIG. 53 shows the half way across the housing, tensile loading.

FIG. 54 shows the pin housing, tensile loading.

FIG. 55 shows across the pin, shear loading.

FIG. 56 presents the pin of the pulling sensor, shear loading.

FIG. 57 shows the housing of the small pins, tensile loading.

FIG. 58 presents the tension of the spring, tensile loading.

FIG. 59 shows the bending of a part of the spring, bending.

FIG. 60 shows shear loading.

FIG. 61 shows shearing of the spring of the lock, shear loading.

FIG. 62 presents the bending of the spring of the lock.

FIG. 63 shows stresses.

FIG. 64 presents point that may be submitted to an excessive amount of stresses.

FIG. 65 shows equivalent to point that may be submitted to an excessive amount of stresses.

FIG. 66 shows force applied to the edge of the rectangular beam before the circular shape.

FIG. 67 presents the original force and equivalent force.

FIG. 68 shows a fillet of 0.3 cm radius will be added to the spring of the lock to reduce the stress concentration factor.

FIG. 69 presents housing of the lock, tensile loading.

FIG. 70 presents a picture of the most powerful cutter that can be found.

FIG. 71 shows the cross section of a tooth of the tool.

FIG. 72 presents that a tool is able to multiply the applied force at the handle by 10 when the length L1 is 10 times L2.

FIG. 73 presents GSM network.

FIGS. 74 and 75 show the layout of the PCB.

FIGS. 76-78 show the connector layout and antenna connectors.

FIG. 79 presents the simply circuit to turn on the GM862-GPS.

FIG. 80 shows the block diagram.

FIG. 81 presents the authentication process that confirms the validity and percentage of fear to activate the Biosensor and GPR/GPS.

FIG. 82 shows the system integration schematic.

FIG. 83 presents the cross-section along the circumference.

FIG. 84 shows the data system response management.

### DETAILED DESCRIPTION OF THE PREFERRED EMBODIMENT

The following is the list of some of the key constraints considered in the initial state of this design:

1. Age Restriction: The age of the user is decided to be between four (4) and fifteen (15) or over sixty-five (65) for various reasons like immaturity, special diseases, safety and attractive to predators

2. Unbreakable: The device has to be unbreakable by commonly used metal cutting tools to improve safety of the user and delay the separation of the device from the user.

3. Rechargeable: Since a user must wear the device for a maximum number of hours on a given day, the device should operate without stopping while charging itself during operation.

4. Adjustable to wrist size: It is required that the product is adjustable to the specified range of wrist size, for it to be cost effective.

5. Nonirritant and Water Proof: Since the device has to be worn at all times the material of the device has to be comfortable and water proof to avoid any possible damage.

6. Light Weight: Since the majority of the users are children, the device has to be very light weight to avoid discomfort.

7. Attractive: It is necessary to make the designed device attractive for children to want to wear it for long periods of time.

The design includes the following features to accomplish the goals and satisfy the needs.

1. GPS: (Global Positioning System)

The Global Positioning System (GPS) is a global navigation satellite system (GNSS) developed by the United States department of defense. It uses a constellation of 32 satellites that transmit precise signals, which enable GPS receivers to determine their current location, the time, and their velocity.

2. Alarm, Feedback and Response:

To get the ultimate peace of mind by outfitting family members or children with a GPS Tracking Bracelet. With “The Bracelet”, one can locate family members instantly and receive alerts if they leave a designated safety zone. If the Bracelet wearer leaves the safety zone, either the primary family contact or the emergency call center will immediately be alerted and can send help if needed. Emergency personnel can be sent instantly based on the GPS locator's readout to locate the family members before it's too late to avoid loss, injury, or death. Immediate family can be contacted in case of people over sixty-five by simply pressing the panic button. Emergency alerts can be sent to family member's cell phone. After logging on to the specific database system, one can see the location of the device user on a map.

Dynamic memory will be saved at the central signal receiving location so that the location of the device can be tracked after the device has indicated panic. There will be a special message which will be transmitted in case of an alarm signal. The device will also be capable of sending an alarm signal in case of any tempering with the device. When this tempering happens, first the location of the device will be sent by a signal.

3. Locking Mechanism and Material:

The design material is strong enough to resist breaking against any metal cutters for the amount of time sufficient for the emergency operation services to respond to the threat. It is important to provide a safety locking mechanism that will keep the user or anyone else from removing the device from the user without consent from the parent or the trusted caretaker

4. Bio-Sensing:

When a person is under fear certain liquid called the adrenaline is released from the glands above the kidney in a normal human body. This release of adrenaline boosts a person's energy to offer a fight or flight option. Since under fear the oxygen level in the blood stream of a normal person varies, the amount of change in oxygen in blood vessels will be sensed and measured by a pulse oxy-meter sensor to make a decision whether to send an alarm to the monitoring services to alarm them about a possible threat to the device user. The pulse Oximeter telesensors are capable of sensing the change in oxygen level in the blood stream as fear instills on the mind of a victim, who is under a possible life threatening situation.

I. Mechanical Design of the Bracelet

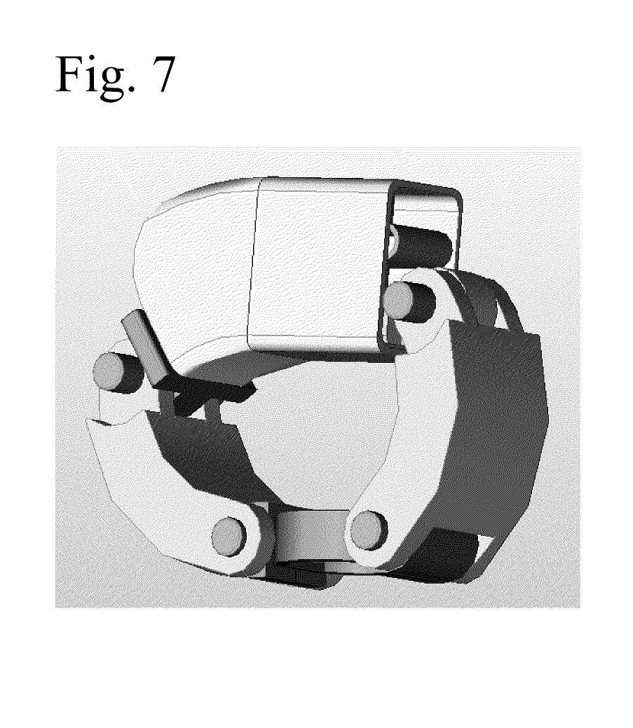

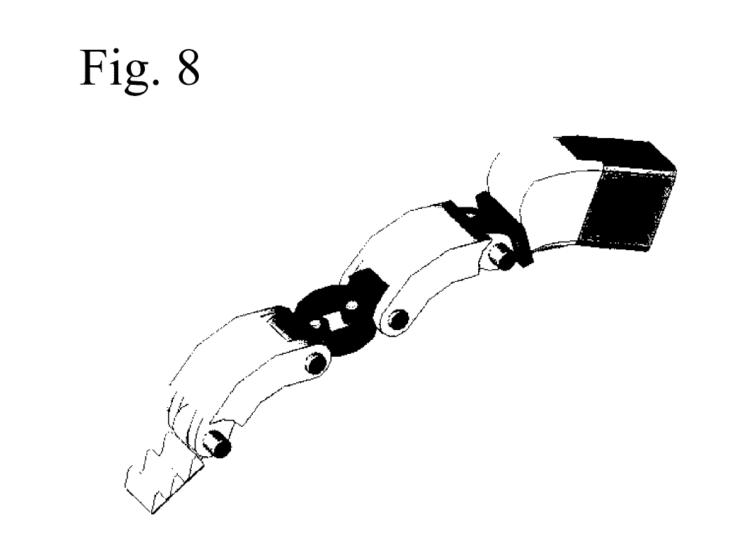

See FIGS. 7 and 8.

(Material used: TITANIUM)

A. Objectives

Physically, the bracelet must be able to verify these abilities:

Containing all the electronic devices

High resistance against threat

Being able to sense threat

Lock difficult to open without the appropriate device

B. Design of Bracelet Parts

The bracelet will have a minimum circumference of 12 cm and a maximum of 16 cm. The locking mechanism will provide that 4 cm flexibility.

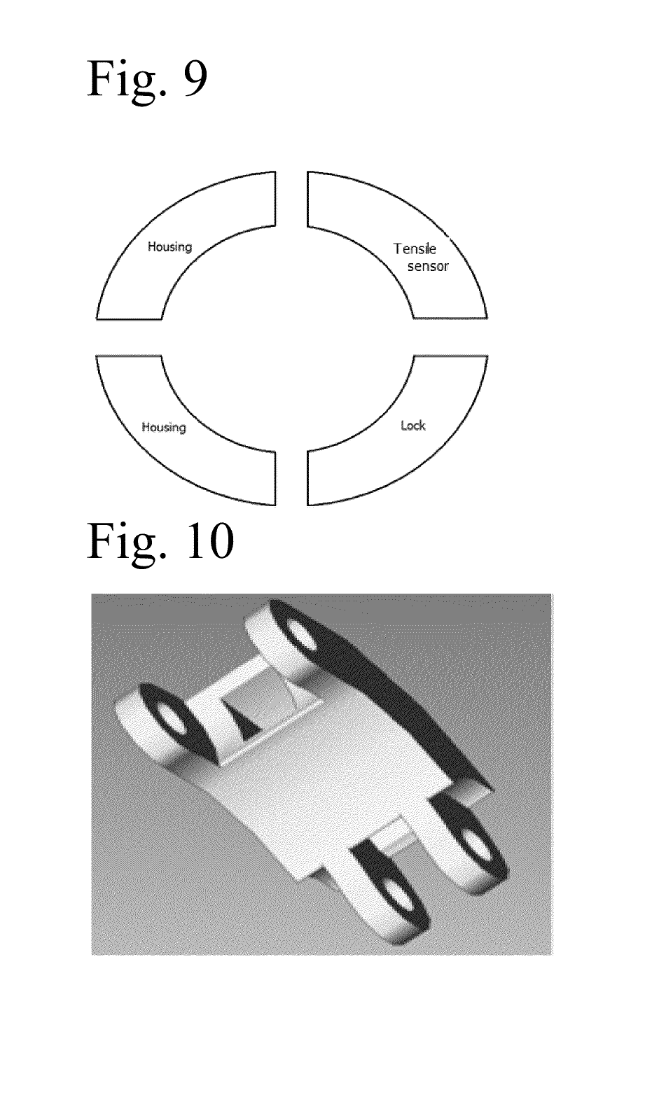

The bracelet will consist of 4 parts at 45 degrees each, 2 housings for the devices and one sensor able to sense tensile loading and one locking mechanism. See FIG. 9.

We will assume that the cross section of the bracelet is 1.5 cm×3 cm, after measurements are taken from a kid's wrist.

Housing for Devices

There will be 2 of the below showed part and each will be able to contain some of the devices. See FIG. 10.

The dimensions of this part will be calculated based on a fully opened bracelet (16 cm of circumference).

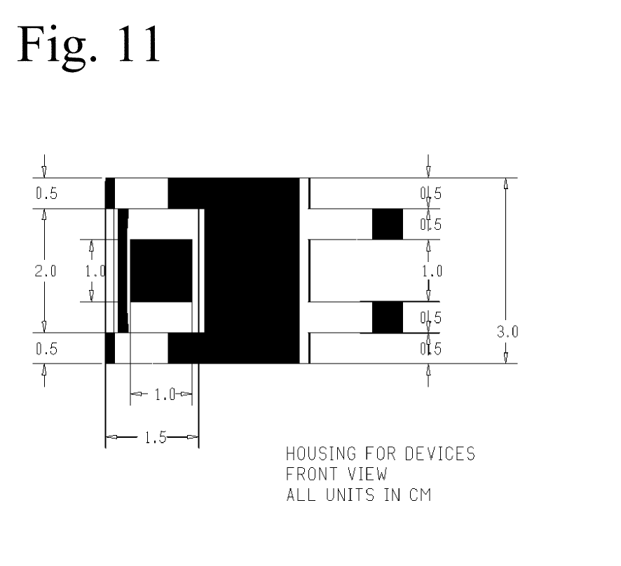

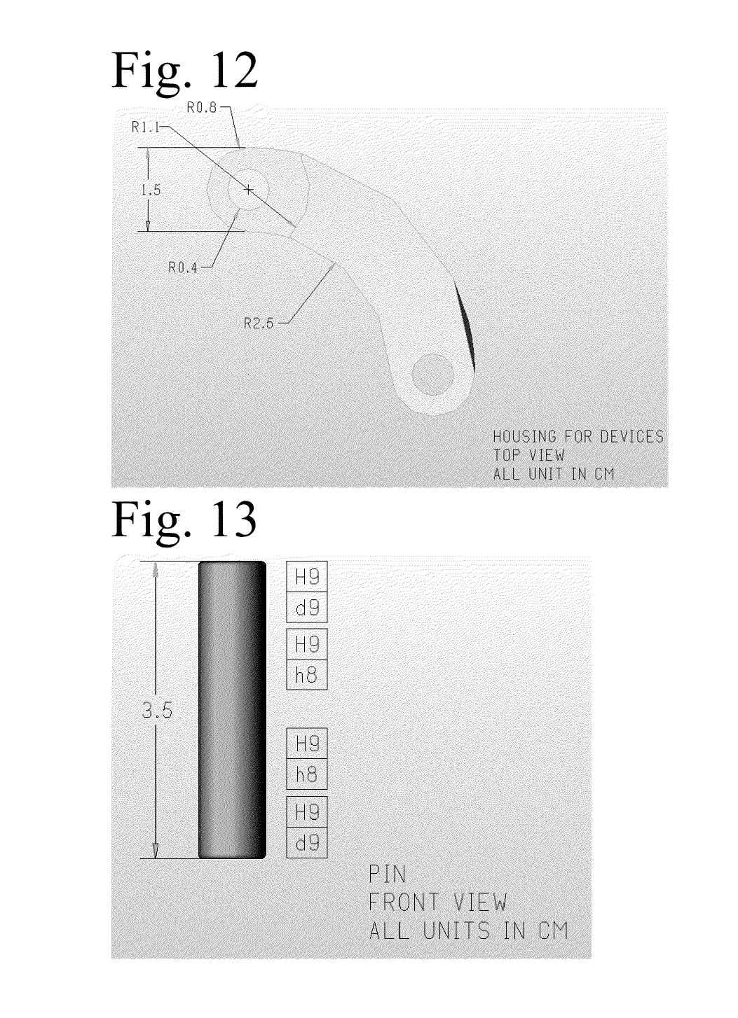

The result is the following: See FIGS. 11 and 12.

The total volume for the devices to be stored is 20.73 cu cm×2=41.46 cu cm

Pins

The objectives of the pins are to maintain the 4 parts making the bracelet together, and to give a rotating flexibility to the bracelet.

So, between each of the 4 parts making the bracelet there will be a cylindrical pin.

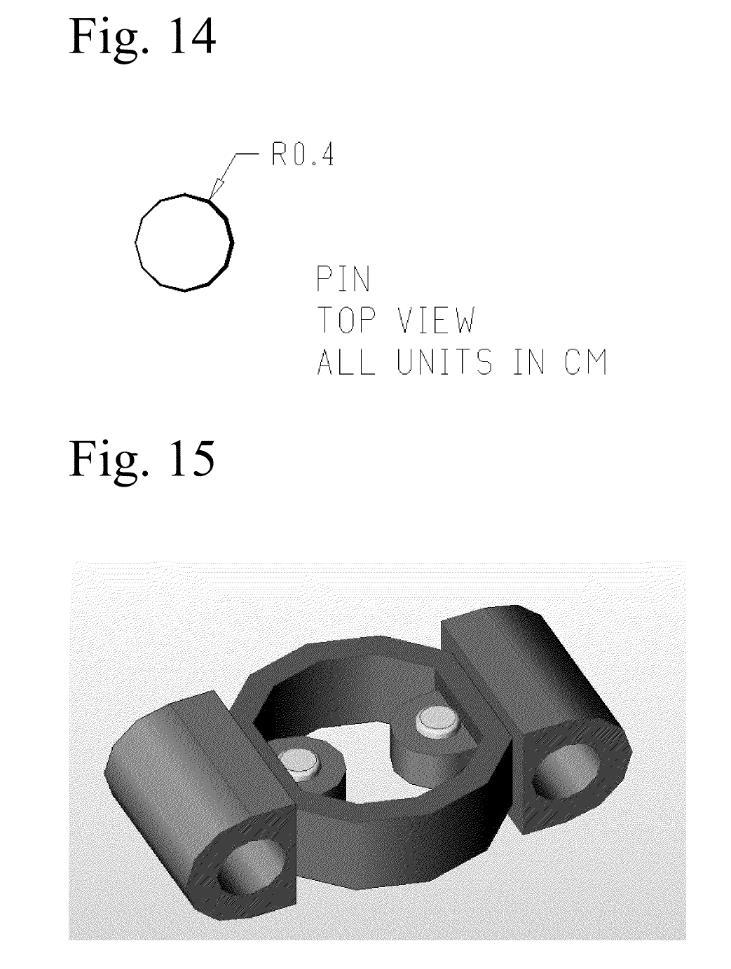

For each pin, the tolerance on one part will be H9/d9 (relative motion) and on the other H9/h8 (NO relative motion, tight fitting). See FIGS. 13 and 14.

NOTE: The state surface and tolerance of the pin (H9) are constant.

Only the housing conditions are different (d9 and h8)

Pulling Sensor (See FIG. 15)

When somebody is pulling the bracelet with a supposed large force, the stresses over the spring (grey part) will overtake its elasticity and there will be a displacement between the two blue parts, the force exerted on the bracelet and the displacement will be measured by a sensor which is a force measurement sensor.

### The Sensor

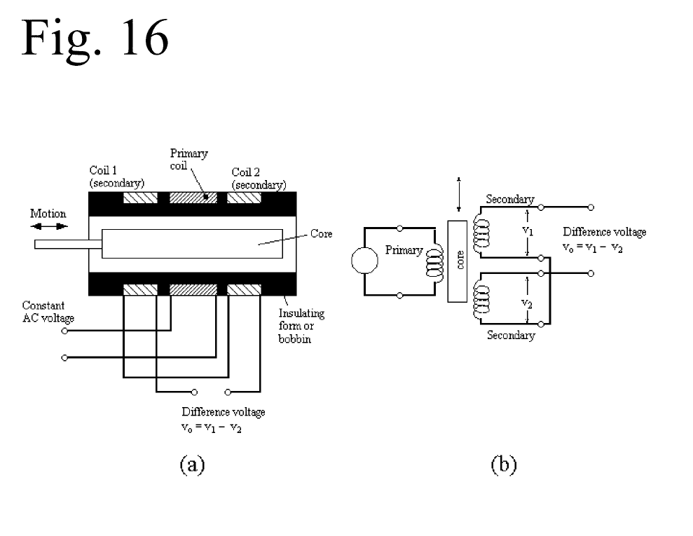

This sensor is a Ring type load cell coupled with a LVDT (linear variable differential transformer) and a Core. The LVDT is shown in the following drawings. See FIG. 16.

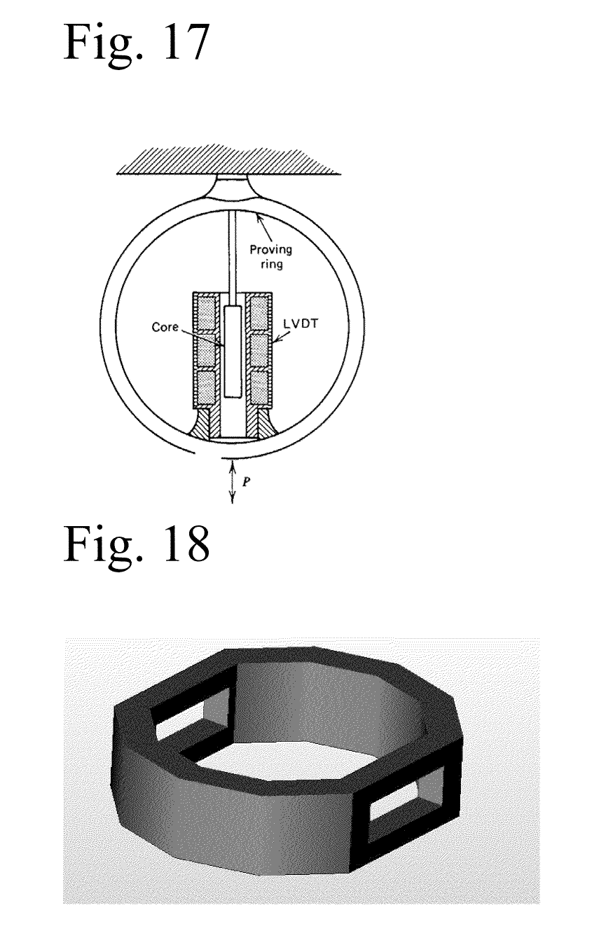

The LVDT will be then mounted between the two blue parts and the Ring Type Load Cell will be the grey part (spring). See FIG. 17.

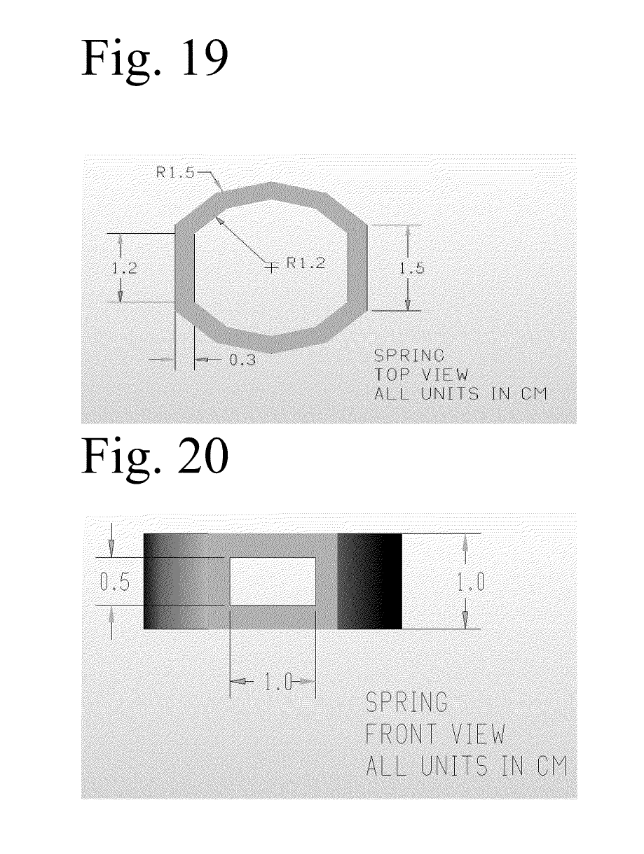

The spring (Ring Type Load Cell) See FIGS. 18-20.

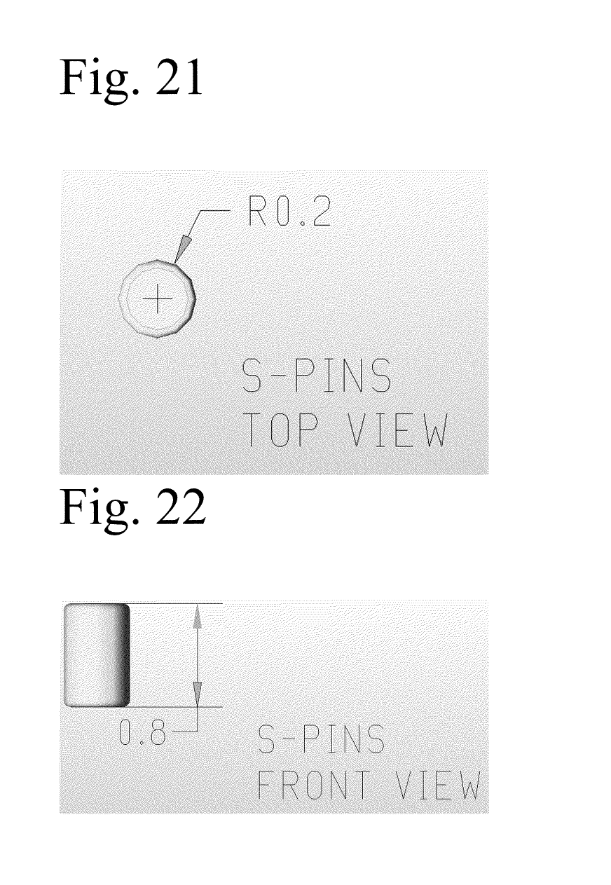

Small pins (See FIGS. 21 and 22)

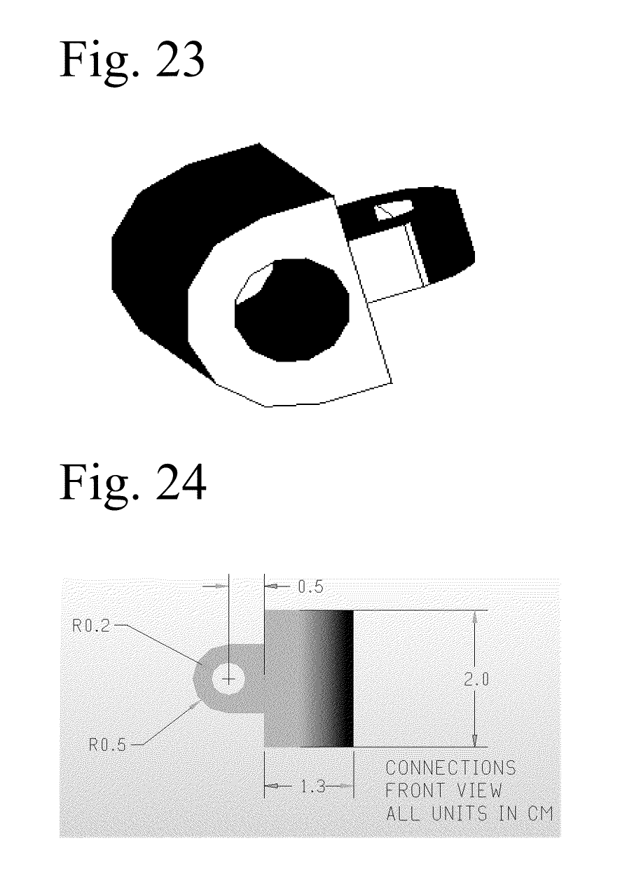

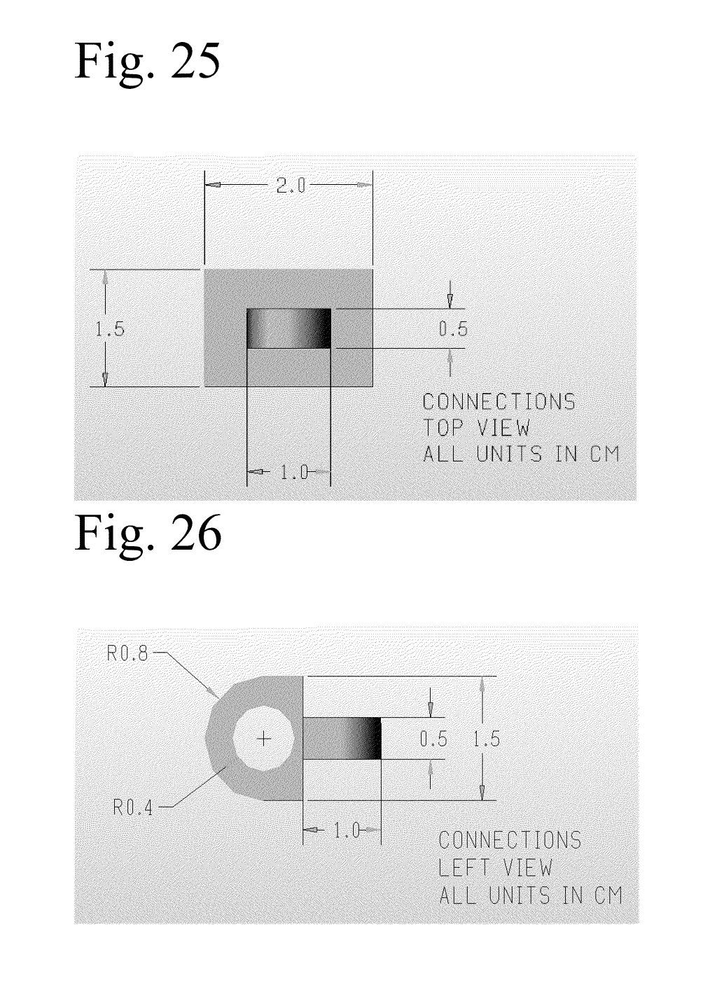

Connectors (See FIGS. 23-26)

### Input and Output of the Sensor

The equation of the displacement is:

$$\text{:} = 1.79 \cdot \frac{P \cdot {R}^{3}}{E \cdot w \cdot {t}^{3}}$$

The equation of the output voltage is:

v₀:=S·δ·v_{S}

P is the force that is exerted on the bracelet

R=1.35 cm

E=95,526 MPa (modulus of elasticity of the titanium)

w=1 cm

t=0.3 cm

S=6.3 (sensitivity of the LVDT)

v 0 is the output voltage

v S is the input voltage

### Calibration of the Sensor

We assume that this sensor has to react when a force of 250 N (25 kgs) is exerted on the bracelet. So P=250 N

The expression of the output voltage is then:

$${v}_{0} \text{:} = S \cdot ( 1.79 \cdot \frac{P \cdot {R}^{3}}{E \cdot w \cdot {t}^{3}} ) \cdot {v}_{s}$$

v₀:=v_{S}·2.662·10⁻⁴

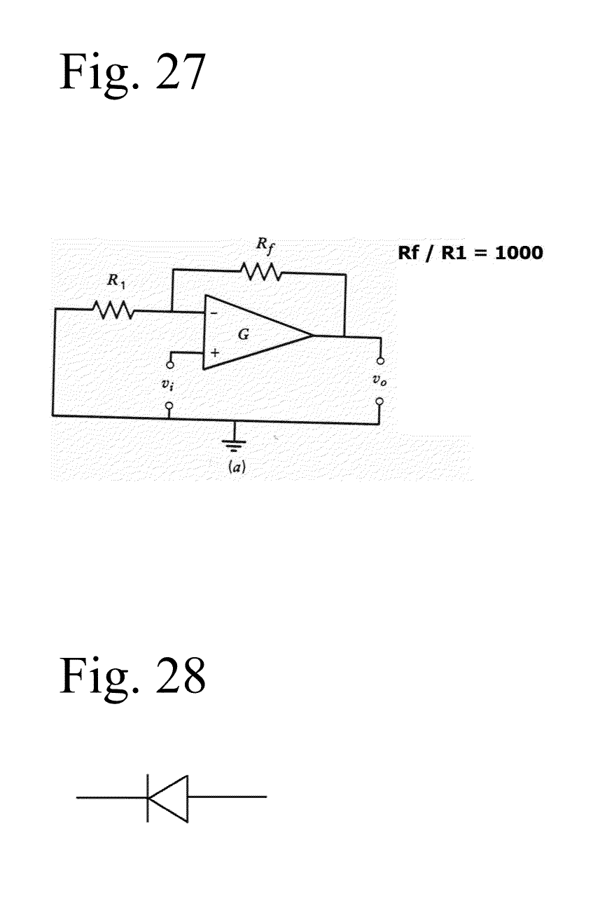

The output is very low, a direct current amplifier of the type Operational amplifier will be needed to multiply the input voltage by 1000. The OP amplifier is shown in the following drawing. See FIG. 27.

Finally, We want our sensor to filter the output voltage of the set LVDT-Amplifier so that, the final output of the entire sensor will be 0 when the force is under 250 Newtons and equal to

v₀:=N v_{S}·2.662·10⁻⁴

When the force is over 250 Newtons

(where N is the ratio of amplification from the operational amplificator, 1000)

For that purpose, we will add an electronic diode that has a forward voltage drop of

v₀:=N v_{S}·2.662·10⁻⁴

Electric Diode (See FIG. 28)

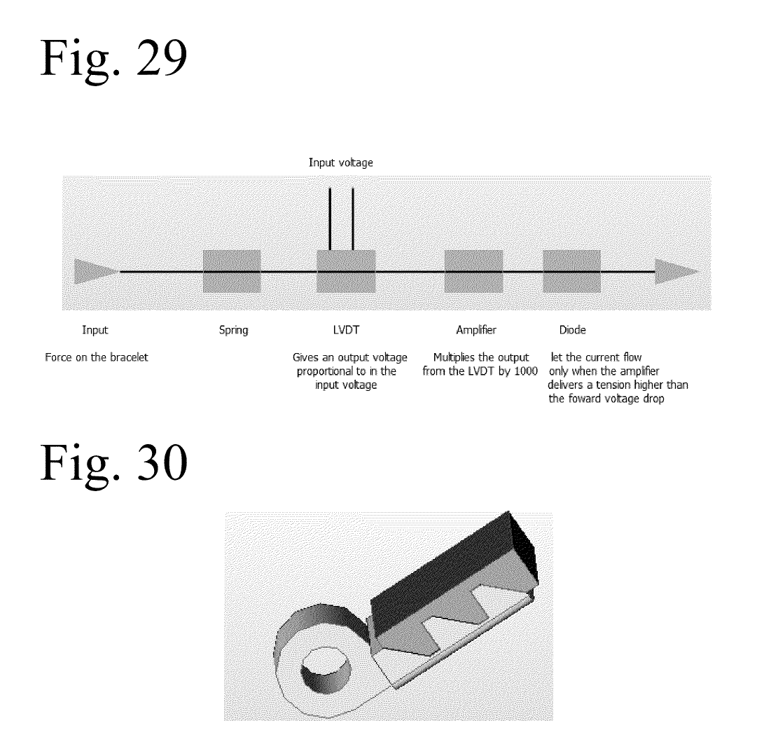

Conclusion (See FIG. 29)

Locking Mechanism

To lock or unlock the bracelet, electromagnetic force will be used. This is the same force that attracts or repulses two magnets.

Two sets of teeth lock the bracelet

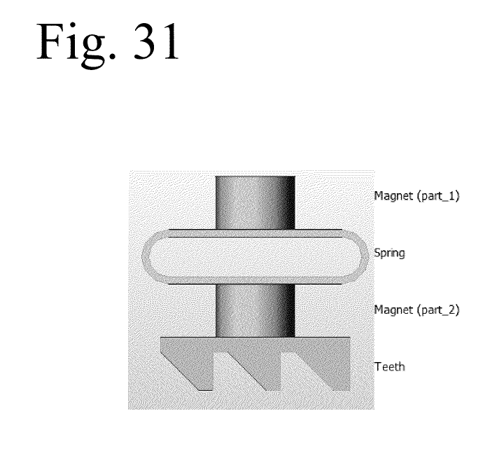

The blue set of teeth has the ability to move up and down, releasing the green set of teeth. A magnet and a spring give that ability to the blue teeth (See FIGS. 30 and 31)

Electric coils go all around part_{—}1 and part_{—}2 of the magnet so that the bottom and the top of each of these parts, have different polarities (+and −). Part_{—}1 and Part_{—}2 will then be attracted to each other when the current flows.

What will be the Force from the Two Magnetic Poles

The equation that can be used is the following

$$F \text{:} = [ \frac{{B}^{2} \cdot {A}^{2} \cdot ( {L}^{2} + {R}^{2} )}{π \cdot μ \cdot {L}^{2}} ] \cdot [ \frac{1}{{x}^{2}} + \frac{1}{{( x + 2 \cdot L )}^{2}} - \frac{2}{{( x + L )}^{2}} ]$$

B is the magnetic flux density very close to each pole, in Tesla,

A is the area of each pole, in m²,

L is the length of each magnet, in m,

R is the radius of each magnet, in m, and

x is the separation between the two magnets, in m

Each pole is a solenoid (coil)

The value of the magnetic flux of a solenoid is given by

$$B \text{:} = μ \cdot n \cdot \frac{u}{r} ,$$

where u is the voltage across the solenoid
l is the length of the wire used,
r is the electrical resistivity of the wire used (we assume copper)
and n is the number of coil in each of the two poles

for, u=50 Volt

F is approximately equal to 100N (10 Kgs)

This is the force that pushes the two teeth away from each other.

What is the Amount of Electric Power Used by the Lock

One magnetic pole is a solenoid.

The power used by a solenoid is P=Z i ²

The impedance of a solenoid is Z:=L·w, where L is the inductance of the solenoid, w is the pulsation of the power source domestic electric power source f=60 Hz; therefore, w=377 rad/s)

L is the inductance:

$$:= \frac{N \cdot Φ}{i} ,$$

Where N is the number of coils i is the intensity of the current and Φ is the magnetic flux

$$:= \frac{{BS}^{2}}{2} ,$$

Where B is the magnetic flux density and S is the section of the magnetic pole

Using the above equations, with some iterations lead us to this result:

The power used by the bracelet during the locking or unlocking phase is approximate to be 15 watt.

That power is provided by the domestic electric source (120 volts). A voltage reducer reduces the voltage to 50 volts and changes from AC to DC.

How to Lock and Unlock the Bracelet

The two magnetic poles are connected to a domestic power source of 110V.

In the bracelet there will be a relay that will let the current flow through the electric coils only when the corresponding card has been inserted into the card reader.

Then it is possible to lock or unlock the bracelet.

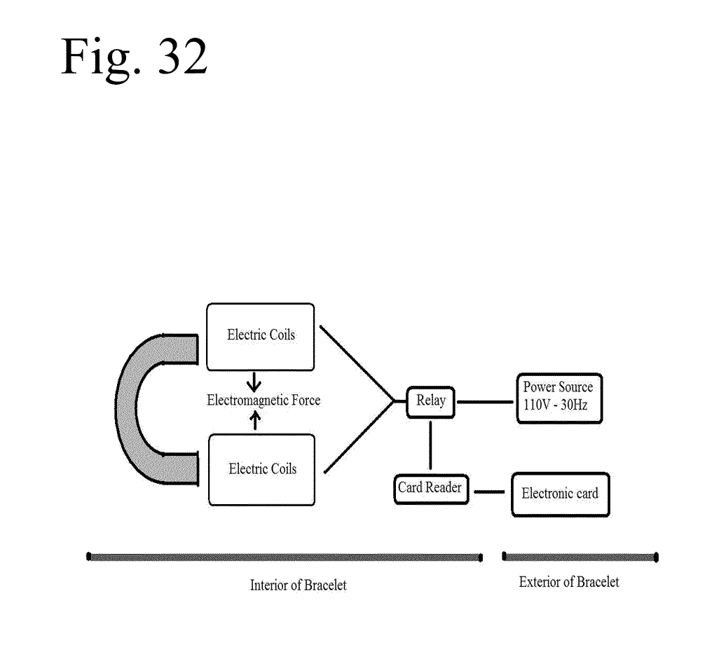

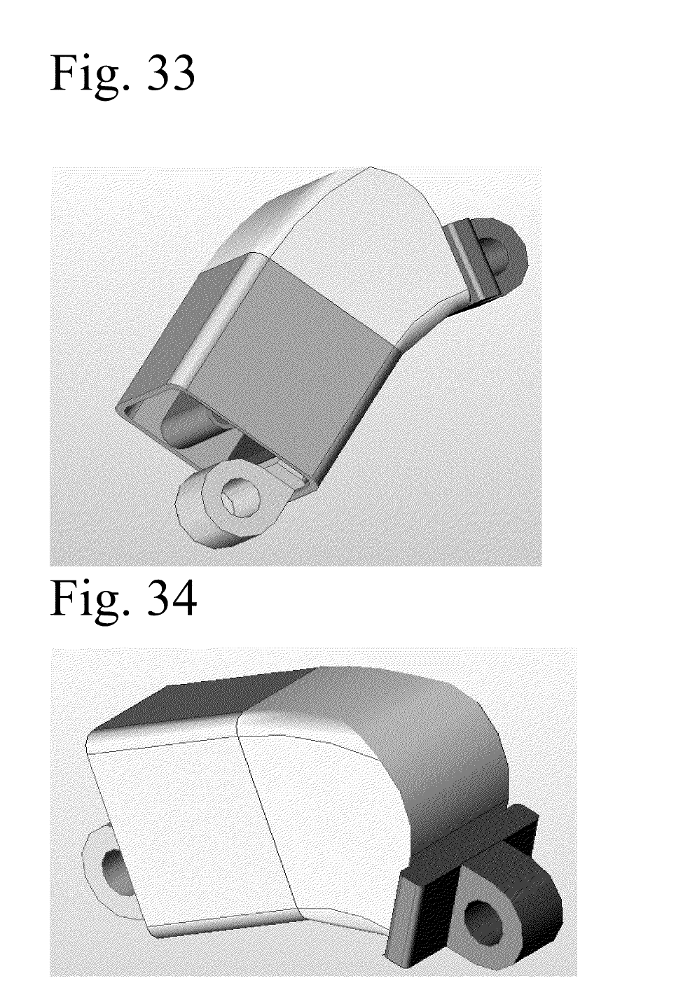

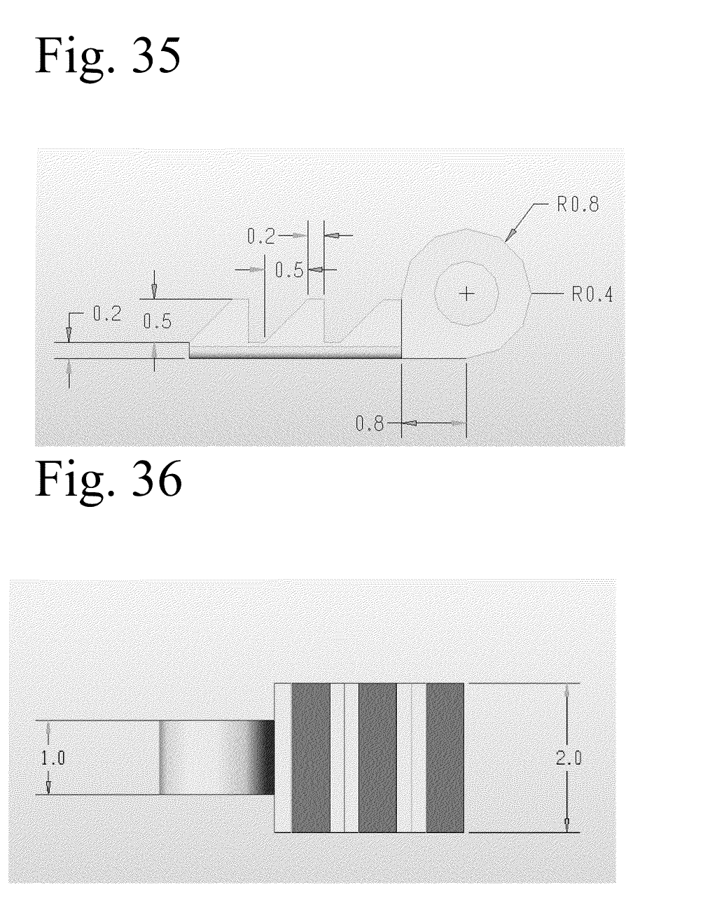

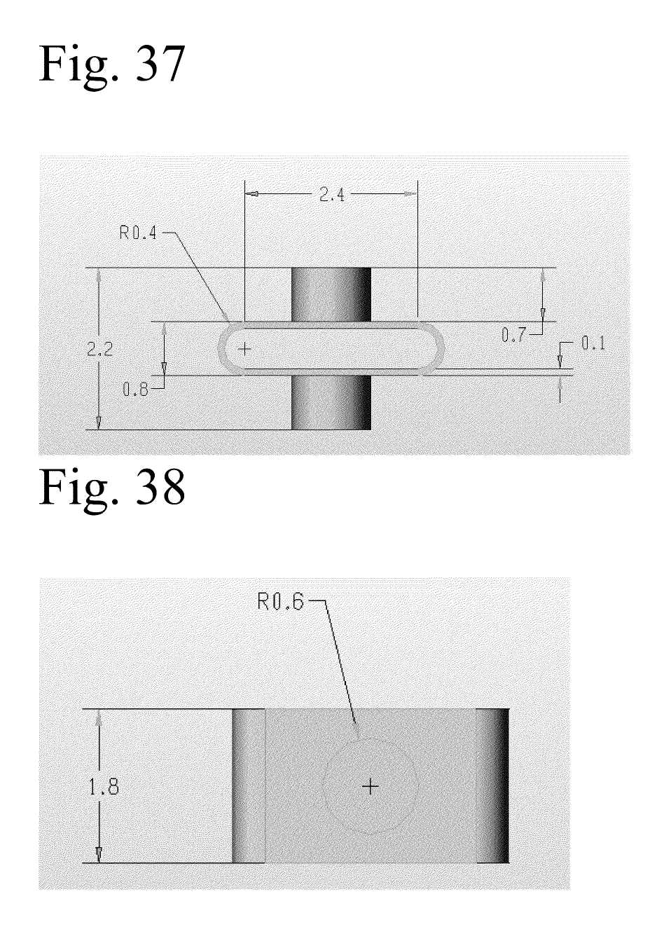

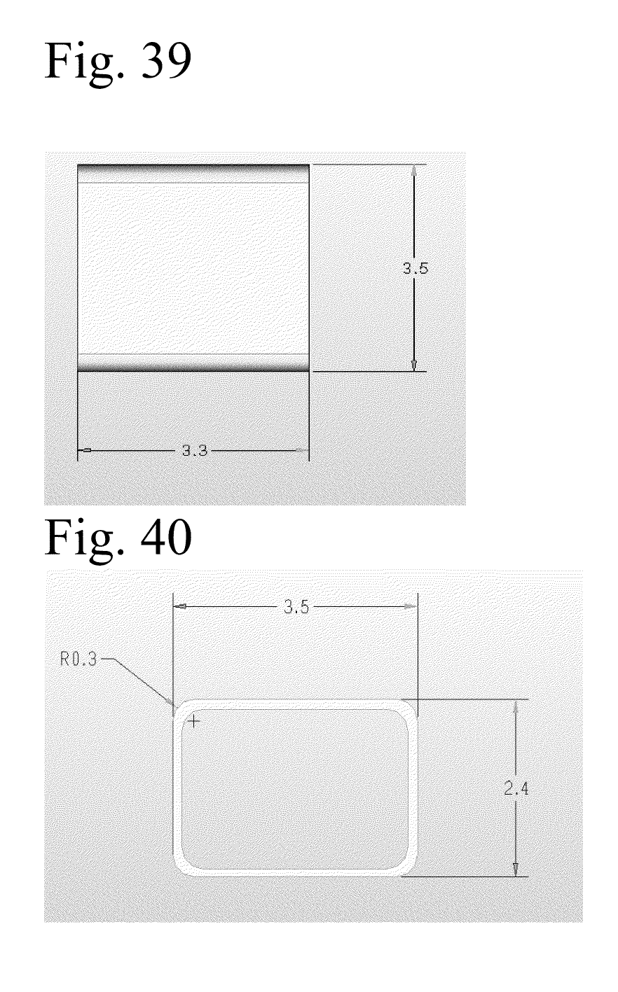

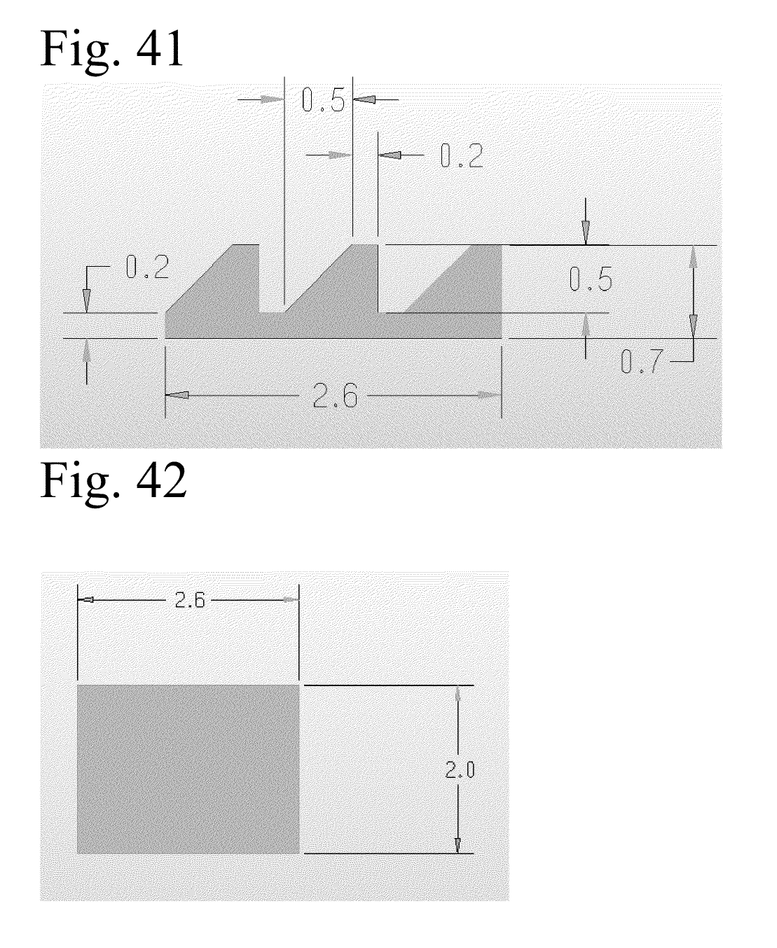

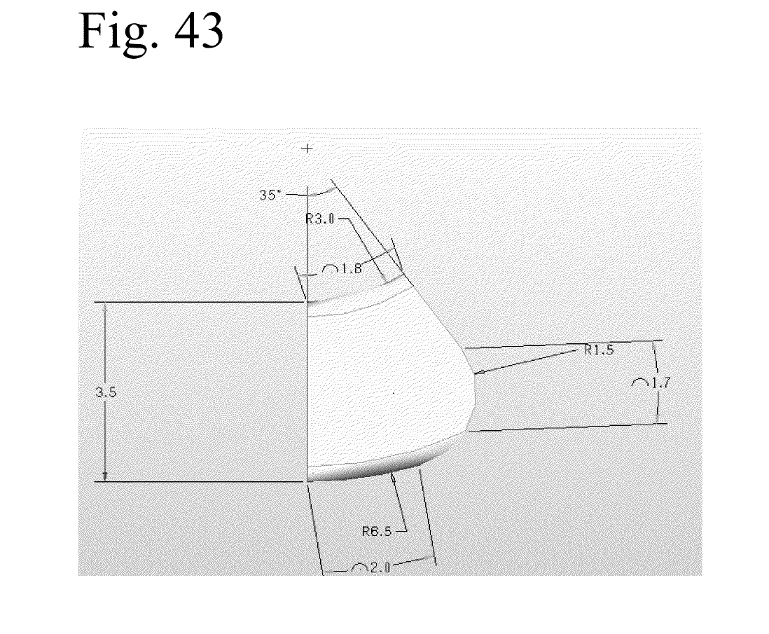

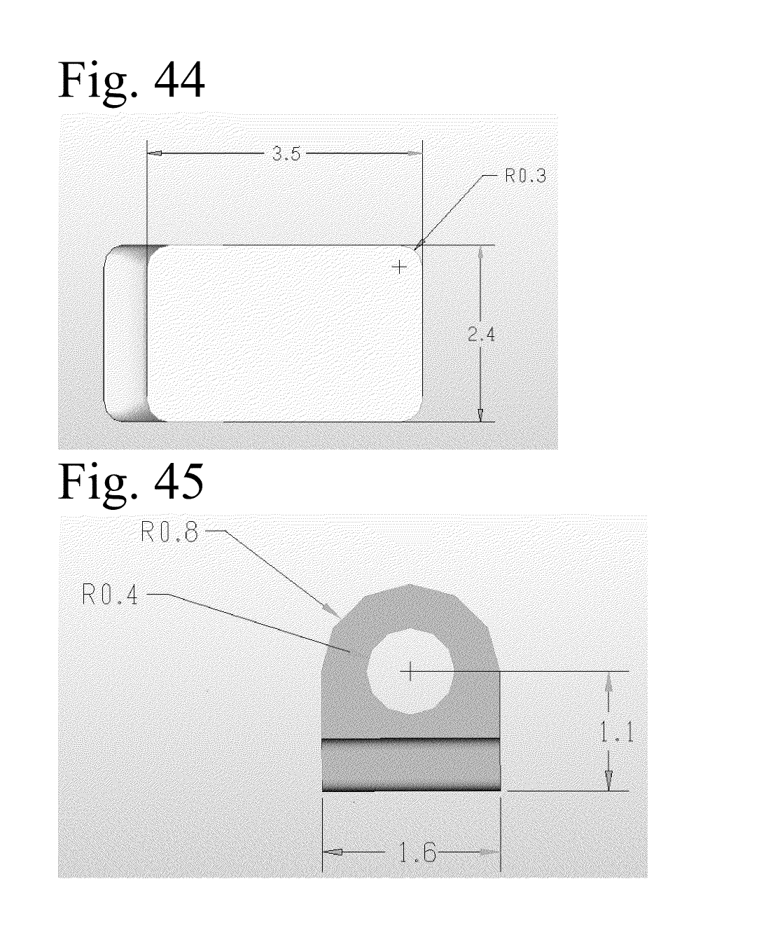

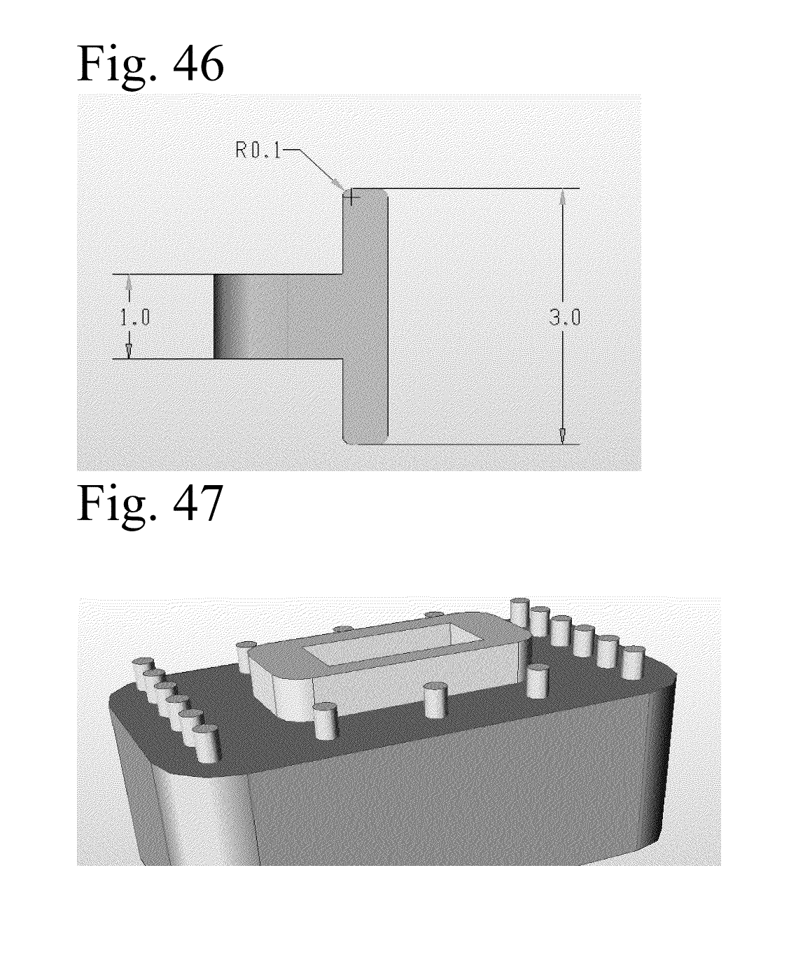

Drawings (See FIGS. 32-46)

Cutting Sensor

This is a hidden set of wires that covers the entire bracelet

If someone uses scissors or a cutter to cut the bracelet, each of these wires will be cut one by one before the bracelet and an electric current is then interrupted. The electronic components can easily interpret the interruption of the current as a threat. See FIG. 47.

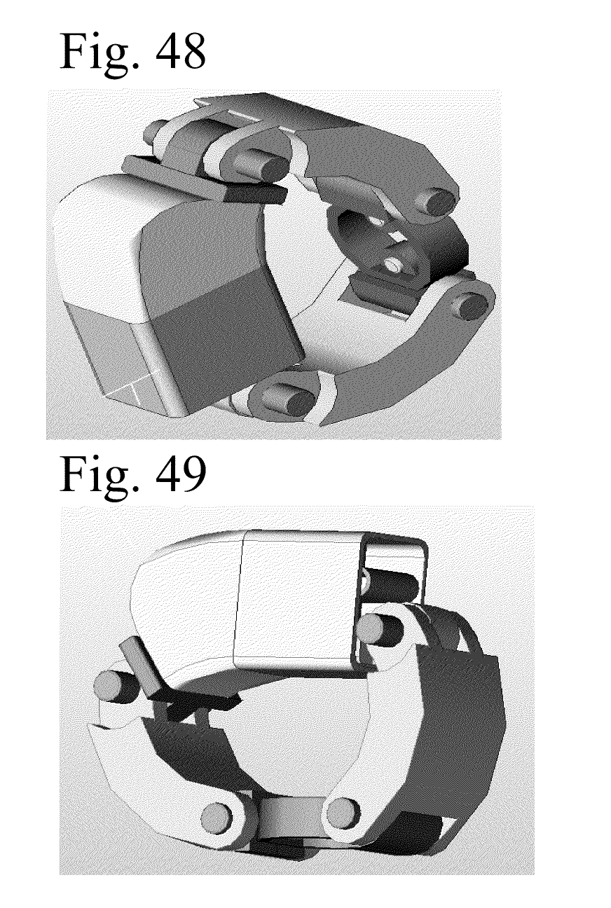

The Entire Bracelet (See FIGS. 48 and 49)

C. Material Selection

For our bracelet, we need a light and strong material wieldable. That's why we have selected the TITANIUM Ti-6Al-4V (Grade 5), Annealed

| | | |
|---|---|---|
| Density | 4.43 | g/cc |
| Tensile strength ultimate | 950 | MPa |
| Tensile strength yield | 880 | MPa |
| Modulus of elasticity | 113.8 | GPa |
| Shear strength | 550 | MPa |

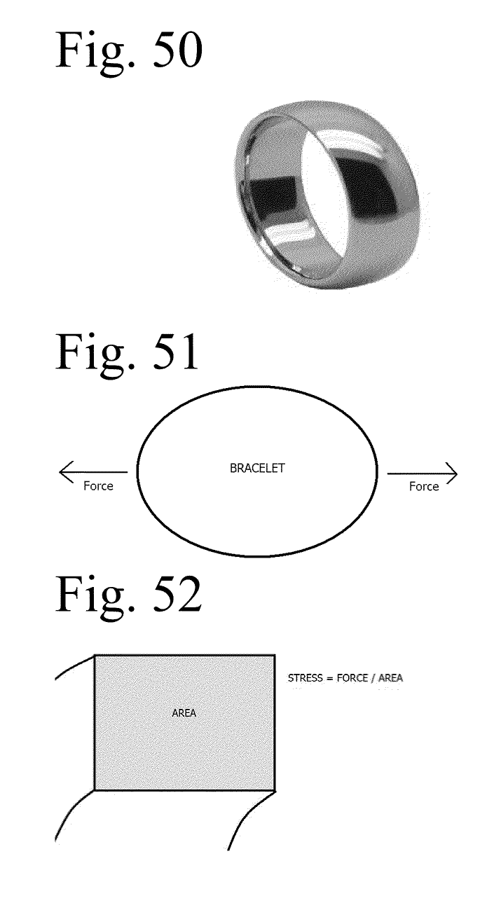

Pure titanium Ring (See FIG. 50)

D. Stress Analysis

We assume that the bracelet will be submitted to two kinds of stresses, Tensile and Shear.

### Pulling the Bracelet

The most common way to attack a bracelet is by trying to pull it as follow (See FIG. 51)

The stresses across a section of the bracelet is then (See FIG. 52)

This action will generates tension and shearing on some parts. Our goal is to identify the weakest areas of the bracelet and make sure that our design will not fail.

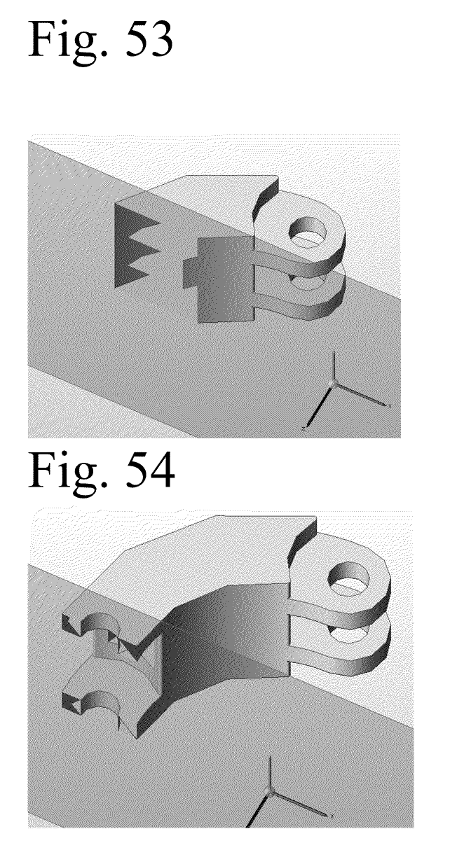

Half way across the housing (tensile loading) (See FIG. 53)

The total area is 0.00035 cu meters

For a tensile strength of 950 MPa, the maximum pulling force is 332500 N=33250 Kgs

At the pin housing (tensile loading) (See FIG. 54)

The total area is 0.00004 cu meters

For a tensile strength of 950 MPa, the maximum pulling force is 38000 N=3800 Kgs.

NOTE: Many parts of the bracelet have similar sections to this one, specially at the articulations, where there is the pin.

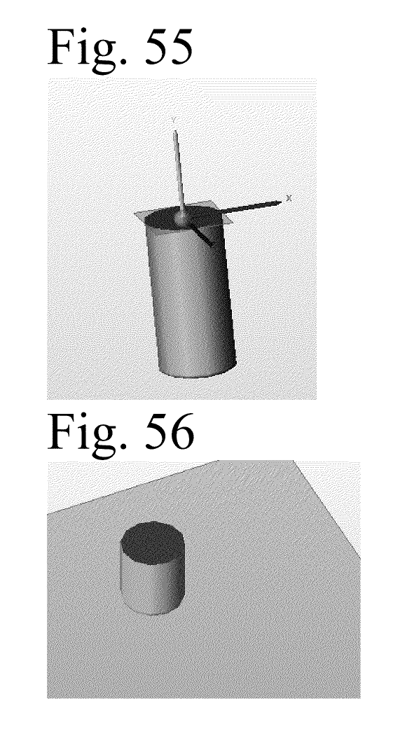

Across the PIN (shear loading) (See FIG. 55)

The total area is 0.0001 cu meters

For a shear strength of 550 MPa, the maximum pulling force is 55000 N=5500 Kgs

The pin of the Pulling sensor (shear loading) (See FIG. 56)

The total area is 0.000025 cu meters

For a shear strength of 550 MPa, the maximum pulling force is 13750 N=1375 Kgs

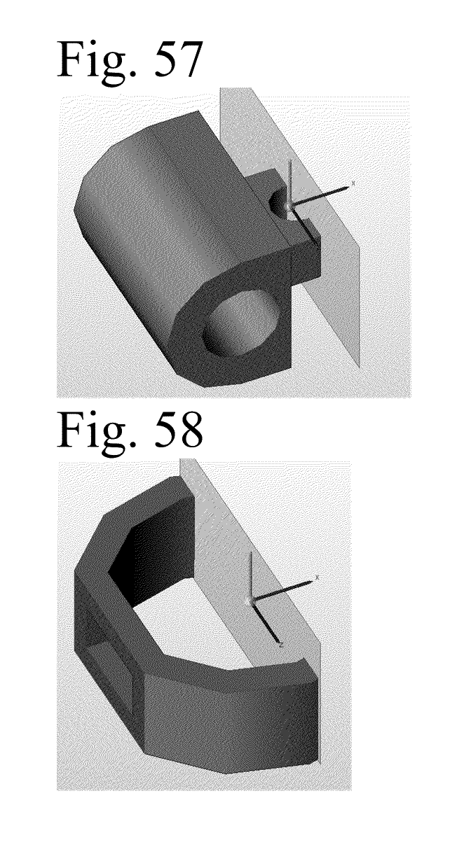

Housing of the small pins (tensile loading) (See FIG. 57)

The total area is 0.0001 cu meters

For a tensile strength of 950 MPa, the maximum pulling force is 95504 N=9550.4 Kgs

Tension of the spring (tensile loading) (See FIG. 58)

The total area is 0.00006 cu meters

For a tensile strength of 950 MPa, the maximum pulling force is 57000 N=5700 Kgs

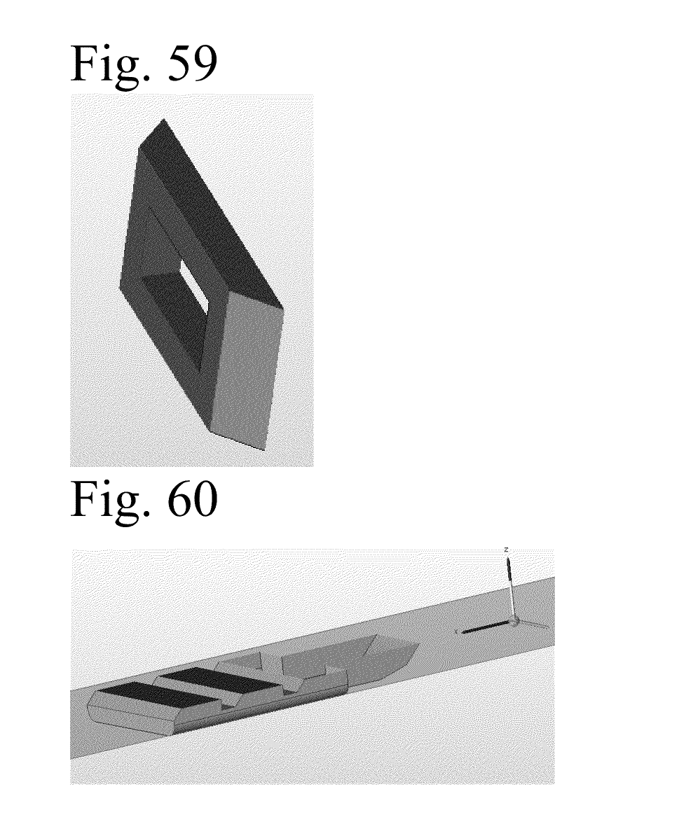

Bending of a part of the spring (bending) (See FIG. 59)

The bending stress is equal to

$$σ := \frac{M \cdot c}{I}$$

where M is the moment, c is the maximum distance from the neutral axis and I is the second moment of area

σ=1.6×10⁶ F

For a maximum tensile strength of 950 MPa, F becomes the maximum force 594 N=59.4 Kgs

Shearing of the teeth (shear loading)

Since each tooth is in contact across its entire length with an opposite tooth, bending is neglected.

The total area is 0.00042 cu meters

For a shear strength of 550 MPa, the maximum pulling force is 231000 N=23100 Kgs

See FIG. 60.

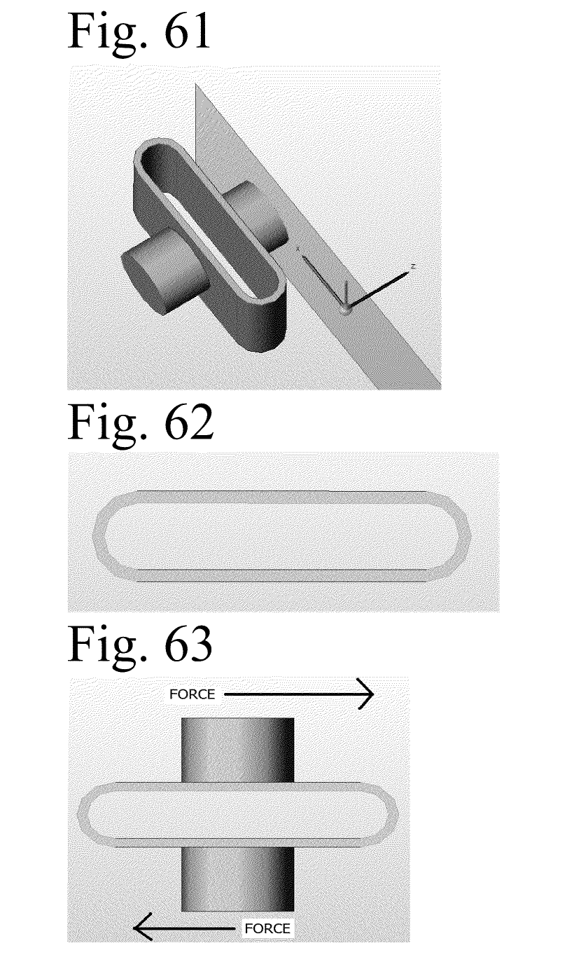

Shearing of the spring of the lock (shear loading) (See FIG. 61)

The total area is 0.0001 cu meters

For a shear strength of 550 MPa, the maximum pulling force is 62203 N=6220.3 Kgs

Bending of the spring of the lock (See FIG. 62)

The bending stress is equal to

$$σ := \frac{M \cdot c}{I}$$

where M is the moment, c is the maximum distance from the neutral axis and I is the second moment of area

σ=4.8×10⁷ F

For a maximum tensile strength of 950 MPa, F becomes the maximum force 194 N=19.4 Kgs

Redesign:

The amount of force that can resist this part is not acceptable.

The thickness of the spring of the lock is then increased from 0.1cm to 0.3 cm.

The maximum force becomes 923 n=92.3 kgs.

The electromagnetic force available to compress this spring and unlock the bracelet is still acceptable (500 n).

Danger zone of the spring of the lock

The spring of the lock is submitted to these stresses (See FIG. 63)

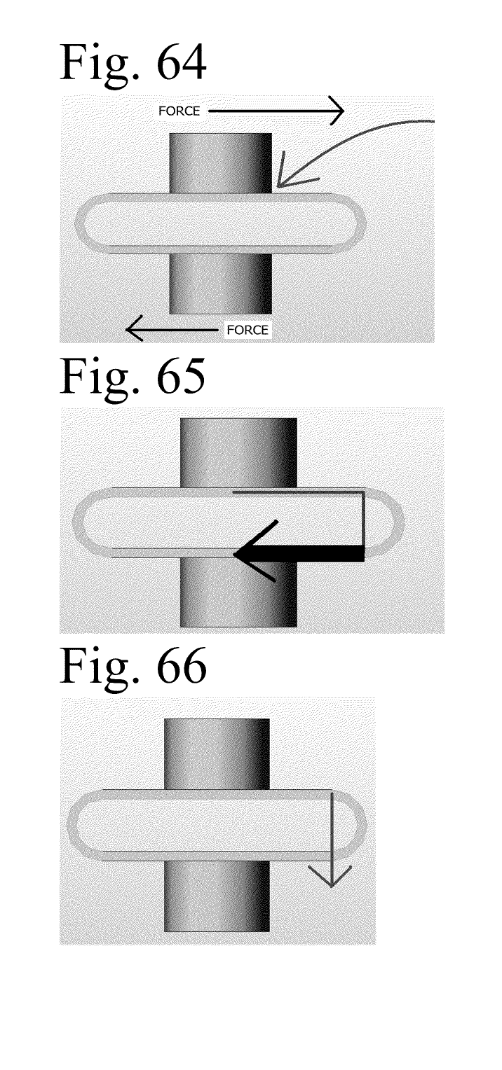

The point that may be submit to an excessive amount of stresses is shown in the following figure. See FIG. 64.

That situation is equivalent to (See FIG. 65)

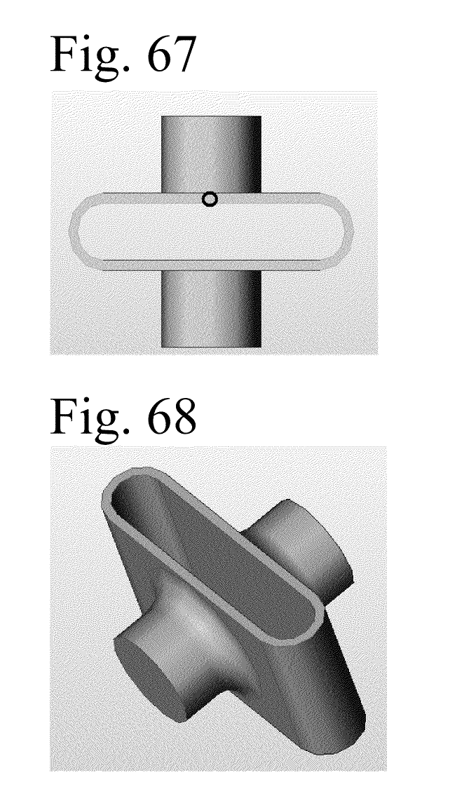

It is like a force is applied to the edge of the rectangular beam before the circular shape (See FIG. 66)

Let's call the original force (black force) Fb and the equivalent force (red force) Fr

These two forces have the same moment with respect to the axis shown as follow (See FIG. 67)

M(Fb)=M(Fr) where M(Fb)=Fb*0.8 M(Fr)=Fr*1.2 (in cm)

Finally, Fr=0.7*Fb

Finally, stresses on the danger point are very hard to compute, but are assumed to be very high.

A fillet of 0.3 cm radius will be added to the spring of the lock to reduce the stress concentration factor. See FIG. 68.

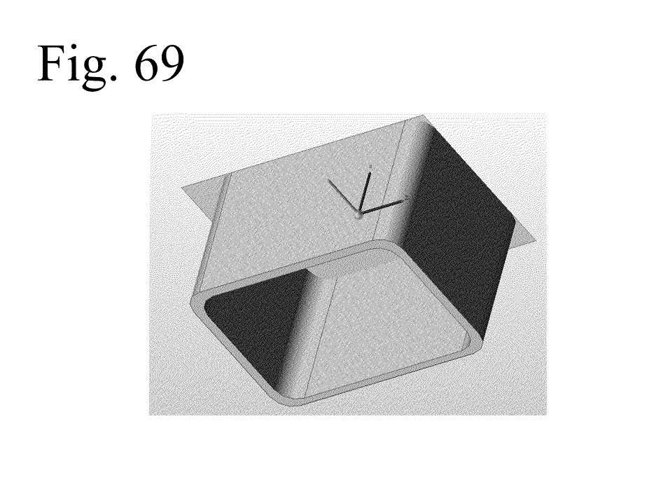

Housing of the lock (tensile loading) (See FIG. 69)

The total area is 0.00012 cu meters

For a tensile strength of 950 MPa, the maximum pulling force is 114000 N=11400 Kgs

### Cutting the Bracelet

Using cutter is a way of threatening the bracelet.

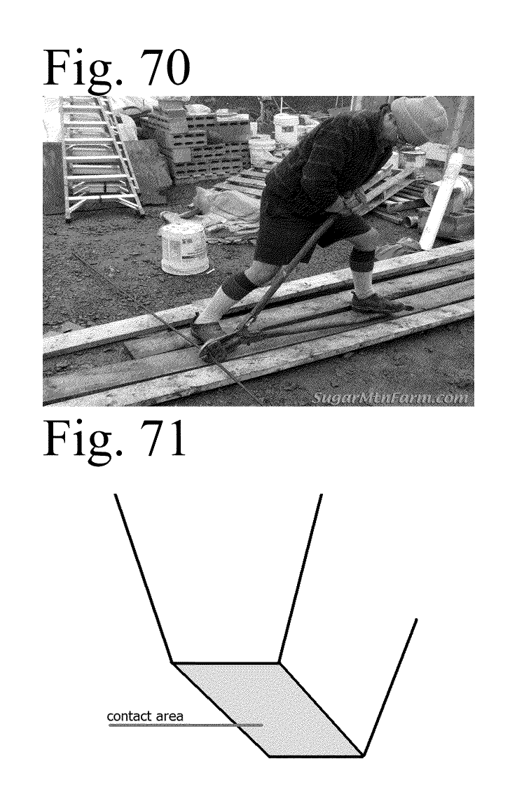

The following is a picture of the most powerful cutter that can be found, capable of multiplying by 10 the force applied. See FIG. 70.

### Let's Find Out if such a Tool Can Damage Our Bracelet

The cross section of a tooth of the tool above is shown as follow (See FIG. 71)

We assume a very small contact area with the titanium of 0.002×0.004 (meters)=8 square micro meters

When the tool is applied to the bracelet, we assume that an equivalent area will be submitted to shear loading since that area is very small.

For a shear strength of 550 MPa, the maximum allowable force is then 4400 N=440 Kgs

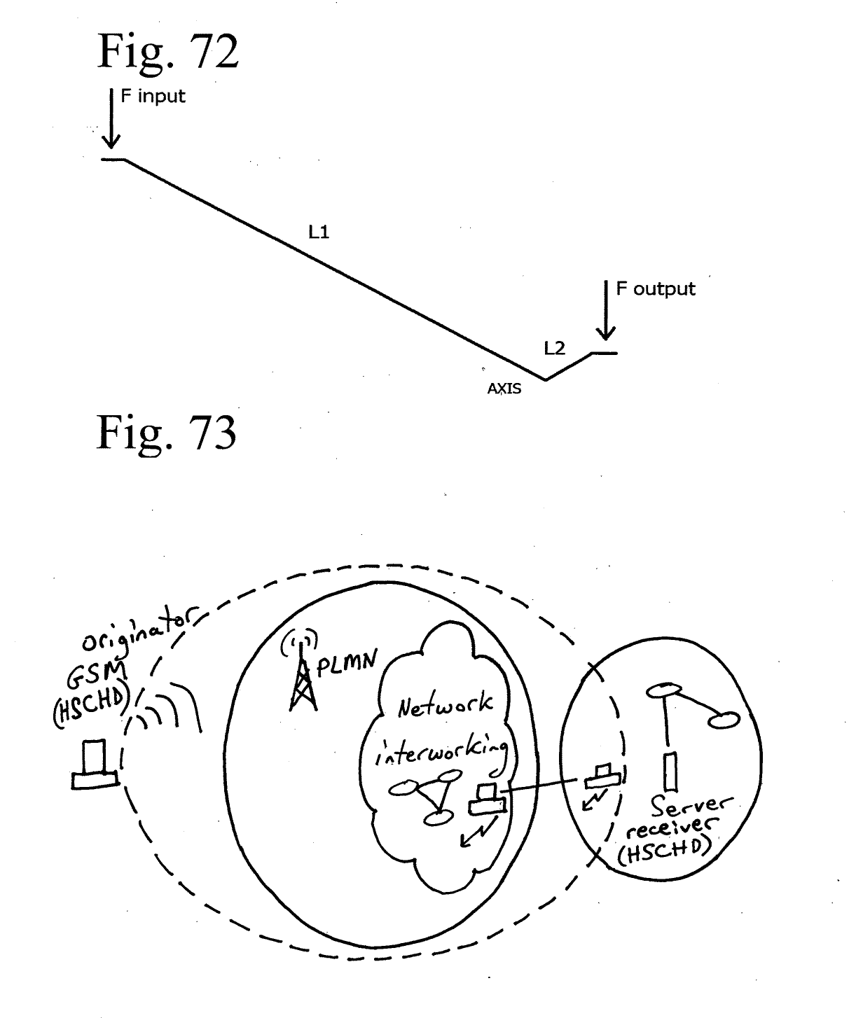

That force is at the tooth location, but such a tool is able to multiply the applied force at the handle by 10 when the length L1 is 10 times L2 (See FIG. 72)

The final allowable force is then 440 Kgs divided by 10=44 Kgs

This amount of allowable force is no extremely high but, such a tool is designed to cut large pieces of metal and since our bracelet is very small, it will be very hard to be used because there will be no room when attached to a kid's wrist.

E. Conclusion of the Mechanical Design

The material selected is TITANIUM Ti-6Al-4V (Grade 5), Annealed

There will be 41.46 cu cm of space to install the devices

A Ring Type Load Cell coupled with a LVDT, an Operational Amplifier and a Diode will be parts of the pulling sensor.

The lock uses magnetic poles to release the tooth and unlock the bracelet, taking a approximate power of 75 watts.

A relay and a card reader will also be parts of the unlocking system of the bracelet.

The weakest element of the bracelet is the spring of the lock, able to resist to a force of 92.3 kgs

NOTE: According to the principle of NEWTON “Action-Reaction”, two forces of 92.3 kgs will have to be exerted to the bracelet before damaging it.

Tensile strength: maximum force in tensile loading 92.3 Kgs

Shear strength: maximum force using a very large cutter 45 Kgs

In case the lock doesn't open, a special log nut will be used to remove one of the pins

Since the bracelet is very small, some parts are welded such a way that the weld is applied on the entire surface of contact. Those welding areas have then been neglected during the stress analysis.

The following sections discuss the design in detail and highlight the essential features incorporated in the final product.

IV. Electronic Design of the Bracelet

A. GPS/GPRS

### GPRS Functions, Selection Process and Advantages

Response System using GPRS:

In our design we are integrating a GPRS (General Packet Radio Service) communication unit, design to transmit information triggered by an alarm system to an alarm receiving center, using a GPRS wireless network. The wireless capabilities are a key component in the alarm system.

There are several major second-generation or 2G digital cellular standards used throughout the world. The most widespread are GSM, the CDMA (Code Division Multiple Access) standard called cdmaOne, TDMA and PDC (Personal Digital Communications). Over the last few years, there has been a transition to 2.5G and 3G technologies that, in addition to voice services, has added support for always on packet data access and new multimedia types of wireless service.

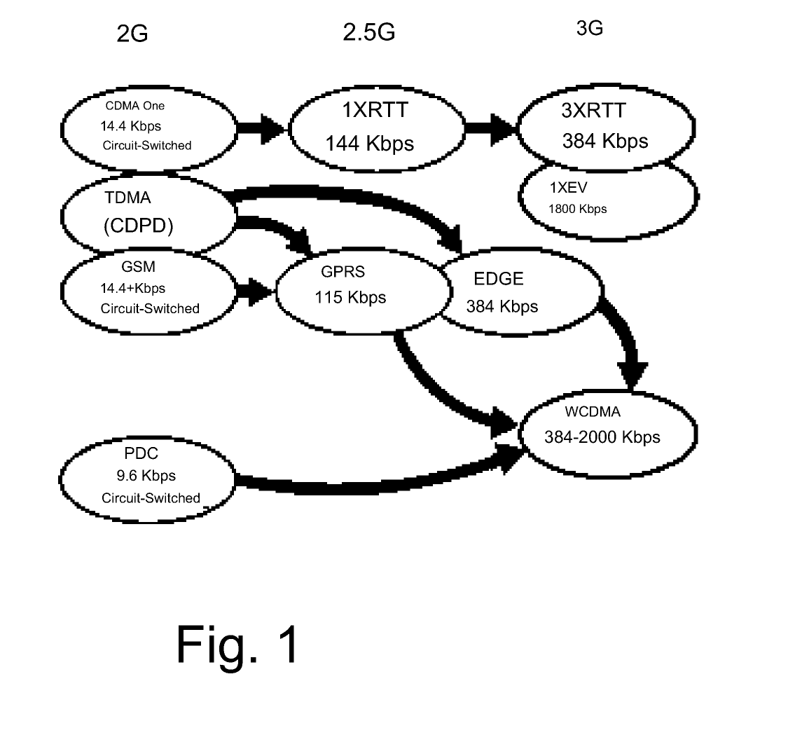

More than two out of three digital cellular subscribers worldwide connect using GSM, making GSM the dominant worldwide standard. A number of major TDMA service providers have decided to deploy GSM/GPRS overlays, rather than continuing on a separate and unique evolution path towards 3G networks. FIG. 1 shows the evolution paths of current technologies to 2.5G and 3G. See FIG. 1 for cellular network evolution.

### GSM

GSM (Global System for Mobile Communications) is the dominant 2G digital mobile phone standard for most of the world. It determines the way in which mobile phones communicate with the land-based network of towers. GSM is one of two major mobile phone technologies in the U.S. The other is CDMA. Cingular and T-Mobile use GSM. Sprint and Verizon use CDMA. GSM is more prevalent in most other parts of the world, and especially in Europe. Although GSM and CDMA provide similar basic features and services to end-users, (such as voice calling, text messaging, and data services,) they operate very differently at many technical levels. This makes GSM phones completely incompatible with CDMA networks, and vice-versa. The most visible feature of GSM is SIM cards. SIM cards are removable, thumbnail-sized smart cards which identify the user on the network, and can also store information such as phone book entries. SIM cards allow users to switch phones by simply moving their SIM card from one phone to the other.

GSM is the most popular cellular technology in the world with over a billion subscribers in 85 countries. It's based on TDMA (Time Division Multiple Access). GSM channels are 200 KHz wide and divided into 8 time slots. Each slot can carry a digital telephone call coded at 13 Kbps or 14.4 Kbps of IP or Internet Protocol data. Busy cells may use multiple channels to support the call demand. If you could use an entire GSM channel to carry data, you could have a bandwidth of over 100 Kbps. With compression, the maximum bandwidth for GPRS is 170 Kbps. Don't get your heart set on that rate. GPRS is set up on a class system, with class 8 being the default. Class 8 is known as 4+1. You get 4 time slots for download and 1 for upload. Another popular class is GPRS class 10, also known as 4+2. That's 4 time slots for download and 2 for upload.

### GPRS

In order to send emergency data to the monitoring we are going to use GPRS (General Packet Radio Service) transceiver. GPRS is a popular wireless Internet technology. Unlike Wi-Fi, GPRS shares cell phone channels. GPRS is an add-on to the GSM (Global System for Mobile communications) cellular standard. GSM systems that include GPRS can carry both telephone calls and Internet data, with some phones being able to do both at once. GPRS was invented as part of the move to what is called 3G or third-generation cellular phone service. That's the idea that cell phones can also be computers, e-mail and Web browsers and even TV receivers. It's a tall order for a technology that was originally designed to simply make telephones mobile.

GPRS is a packet—based data bearer service for wireless communication service that is delivered as a network overlay for GSM network. GPRS applies a packet radio principle to transfer user data packets in an efficient way between GSM mobile stations and external data pocket networks. Packet switching is where data is split into packets that are transmitted separately and then reassembled at the receiving and. GPRS supports the world's leading packet—based Internet communication protocols, IP (Internet protocol). Today one of the most important applies of a GPRS technology is in a data transfer from distant places.

GPRS is different to GSM because it offers the following key feature:

Higher bandwidth and, therefore data speeds

Seamless, immediate and continuous communication to the Internet—‘always on line’

Packet—switching rather then circuit—switching, this means that there is higher radio spectrum efficiency because network resources and bandwidth are only used when data is actually transmitted even though it is always connected.

Support for leading Internet communication protocols—Internet Protocol (IP).

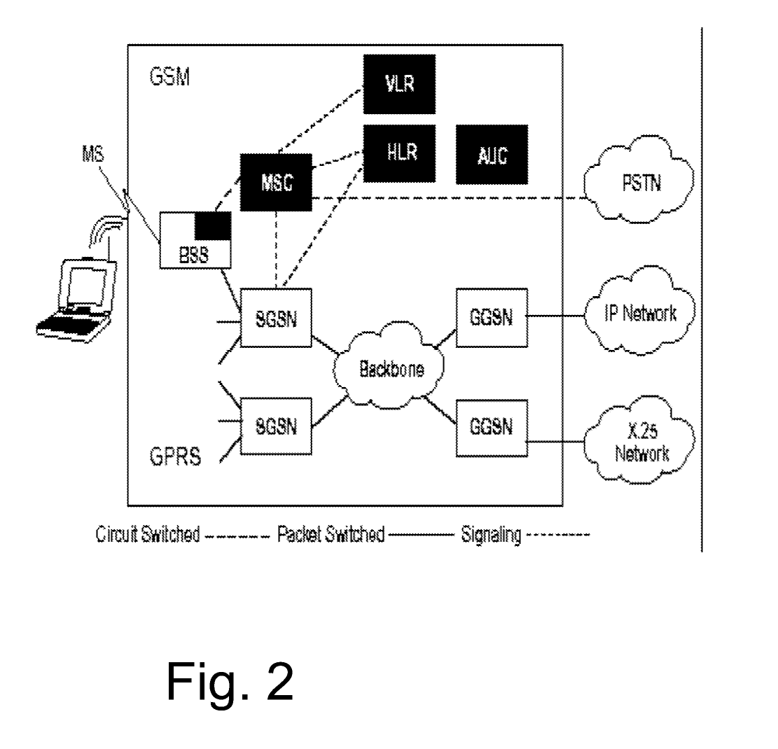

GPRS is a packet data overlay onto existing GSM networks. As a global standard, it is expected to be widely deployed on GSM networks. FIG. 2 presents GPRS architecture. When a user turns on a GPRS device, typically it will automatically scan for a local GPRS channel. If an appropriate channel is detected, the device will attempt to attach to the network. The SGSN (Serving GPRS Support Node) receives the attach request, fetches subscriber profile information from the subscribers and authenticates the user.

The SGSN uses the profile information (including the access-point name, which identifies the network and operator) to determine which GGSN (Gateway GPRS Support Node) to route to. The selected gateway may perform a Remote Authentication Dial-In User Service (RADIUS) authentication and allocate a dynamic Internet Protocol (IP) address to the user before setting up connections to outside networks. This process is called the packet data profile context activation and the setup may vary from one carrier to the next. It may include additional functions like QoS management and virtual private network (VPN) tunnel management. See FIG. 2 for the GPRS architecture.

When the devise sends data, the SGSN routes the packets to the appropriate GGSN. The GGSN then routes the data according to the current context established for the session. Conversely, packets destined for the user are routed to the GGSN associated with the users IP address. The GGSN checks the received packets against the current context, identifies the SGSN that is serving the user and routes the traffic accordingly. The SGSN then forwards the packets to the BSS where the subscriber is located. Each dedicated channel is divided into eight time slots, with each time slot supporting a maximum data transmission speed of 13.4 Kbps. In practice, one of these time slots is reserved for control. While it is possible that in special situations a service operator may choose to allocate the remaining seven time slots to GPRS traffic, the normal allocation reserves two of these time slots for voice traffic. Because Internet access is generally asymmetric, the remaining five time slots available for GPRS traffic are allocated in an asymmetric manner as shown, depending on the type of mobile phones being supported:

### Advantages:

### Faster Data Transfer Rates

GPRS currently supports an average data rate of 115 Kbps, but this speed is only achieved by dedicating all eight time slots to GPRS. Instead, carriers and terminal devices will typically be configured to handle a specific number of time slots for upstream and downstream data. For example, a GPRS device might be set to handle a maximum of four slots downstream and two slots upstream. Under good radio conditions, this yields speeds of approximately 50 Kbps downstream and 20 Kbps upstream. This is more than three times faster than current 14.4-Kbps GSM networks and roughly equivalent to a good landline analog modem connection.

The aggregate cell site bandwidth is shared by voice and data traffic. GPRS operators will vary in how they allocate the bandwidth. Typically, they will configure the networks to give precedence to voice traffic; some may dedicate time slots to data traffic to ensure a minimum level of service during busy voice traffic periods. Unused voice capacity may be dynamically reallocated to data traffic.

With its faster data transfer rates, GPRS enables higher bandwidth applications not currently feasible on a GSM network. The following table compares the performance of typical user applications over a 9.6-Kbps GSM network and a 56-Kbps GPRS network.

### Always-On Connection

An always-on connection eliminates the lengthy delays required to reconnect to the network to send and receive data. Information can also be pushed to the end user in real time. GPRS allows providers to bill by the packet, rather than by the minute, thus enabling cost-effective always on subscriber services. General packet radio service now makes it possible to deploy several new device that have previously not been suitable over traditional GSM network due to the limitation in speed (9600 bps), messages length of the short message service (160 character), dial up time and cost. These applications include Point of sale terminals, tracking systems, and monitoring equipment. It's even possible to remotely access and control in-house appliances and machines. GPRS achieves faster connection speed using cutting-edge technologies.

### GM862-GPS/GPRS

### See FIG. 73

The new GM862-GPS module is at the cutting edge of the Telit product line. It combines superior performance in quad-band GSM/GPRS modem functionality with the latest 20-channel high sensitivity SiRFstarIII™ single-chip GPS receiver. Pin-to-pin compatibility to the previous GM862-GPS module enhances and extends the functionality of new and existing GPS applications. With its ruggedized design, extended temperature range, integrated SIM card holder, and industrial-grade connectors, the Telit GM862-GPS is the ideal platform for mobile applications in areas such as telemetric, fleet management, tracking, security, and vehicle navigation.

The new GPS receiver features low power consumption with position resolution accuracy of less than 2.5 m, SBAS (WAAS and EGNOS) as well as high sensitivity for indoor fixes. These features combined with the available Python™ application development environment translate into a very cost effective and feature rich platform quite capable of becoming the total solution for the complete customer application. Additional features including jamming detection, integrated TCP/IP protocol stack, and Easy Scan® offer unmatched benefits to the application developer without adding cost.

All Telit modules, support Over-the-Air firmware update. Telit is able to update its products by transmitting only a delta file, which represents the difference between one firmware version and another.

1) Dimensions
The Telit GM862-GPS module overall dimension are
Length: 43.9 mm
Width: 43.9 mm
Thickness: 6.9 mm
Volume: 13 cm³

2) Description
The Telit GM862-GPS is provided of the following interfaces:
GSM antenna connector
Board To Board Interface connector
SIM Card Reader
GPS antenna connector

The Telit GM862-GPS board to board connector is a CSTP 50 pin vertical SMD Molex 52991-0508 (male). Molex 52991-0508 (male) GM862 Connector PIN-OUT Pin Signal I/O Function Internal Pull up Type.

1. VBATT—Main power supply Power

2. GND—Ground Power

3. VBATT—Main power supply Power

4. GND—Ground Power

5. VBATT—Main power supply Power

6. A/D—A/D converter @ 11 bit (Input Impedance>100 Kohm) Max 2V input

7. VBATT—Main power supply Power

8. CHARGE AI Battery Charger Input Power

9. EAR_HF+AO Handsfree ear output, phase+Audio

10. EAR_MT−AO Handset earphone signal output, phase−Audio

11. EAR_HF−AO Handsfree ear output, phase−Audio

12. EAR_MT+AO Handset earphone signal output, phase+Audio

13. MIC_HF−AI Handsfree microphone input; phase−Audio

14. MIC_MT+AI Handset microphone signal input; phase+Audio

15. MIC_HF+AI Handsfree microphone input; phase+Audio

16. MIC_MT−AI Handset microphone signal input; phase−Audio

17. ON_OFF I Input command for switching power ON or OFF (toggle command). 47KΩ Pull Up to VBATT

18 AXE I Handsfree switching 100KΩ CMOS 2.8V

19 SIMIO I/O External SIM signal—Data I/O 1.8/3V

20 C103/TXD I Serial data input (TXD) from DTE CMOS 2.8V

21 PWRMON O Module Status ON indication (Signal output for power on/off control of external devices 1KΩ CMOS 2.8V

22 SIMVCC—External SIM signal—Power (3) 1.8/3V

23 RESET I Reset input

24 SIMRST O External SIM signal—Reset 1.8/3V

25 RESERVED—RESERVED—

26 SIMCLK O External SIM signal—Clock 1.8/3V

27 SIMIN I/O External SIM signal—Presence (active low) 47KΩ CMOS 2.8V

28 GPO2/JDR O General purpose output (Open Collector)/Jammer Detect Report Open Collector

29 C106/CTS O Output for Clear to send signal (CTS) to DTE CMOS 2.8V

30 C125/RING O Output for Ring indicator signal (RI) to DTE CMOS 2.8V

31 GPI1 I General purpose input transistor base

32 GPIO8 I/O Configurable general purpose I/O pin CMOS 2.8V Pin Signal I/O Function Internal Pull up Type

33 C107/DSR O Output for Data set ready signal (DSR) to DTE CMOS 2.8V

34 GPIO9 I/O Configurable general purpose I/O pin CMOS 2.8V

35 TX_GPS O TX Data NMEA GPS protocol CMOS 2.8V

36 C109/DCD O Output for Data carrier detect signal (DCD) to DTE CMOS 2.8V

37 C104/RXD O Serial data output to DTE CMOS 2.8V

38 GPIO10/CLK I/O Configurable general purpose I/O pin/Python DEBUG 4) CMOS 2.8V

39 STAT_LED O Status indicator led Open Collector

40 GPIO11 I/O Configurable general purpose I/O pin 4.7 Kohm CMOS 2.8V

41 RX_GPS I RX Data NMEA GPS protocol CMOS 2.8V

42 GPIO12 I/O Configurable general purpose I/O pin 47 Kohm CMOS 2.8V

43 C108/DTR I Input for Data terminal ready signal (DTR) from DTE CMOS 2.8V

44 GPIO13/MRST I/O Configurable general purpose I/O pin/Python DEBUG (4) CMOS 2.8V

45 C105/RTS I Input for Request to send signal (RTS) from DTE CMOS 2.8V

46 GPIO3 I/O Configurable general purpose I/O pin 47 Kohm CMOS 2.8V

47 GPIO4 I/O Configurable general purpose I/O pin/TX Disable Control 4.7 Kohm CMOS 2.8V

48 GPIO5/MTSR I/O Configurable general purpose I/O pin/Python DEBUG (4) CMOS 2.8V

49 GPIO6/ALARM I/O Configurable general purpose I/O pin/ALARM CMOS 2.8V

50 GPIO7/BUZZER I/O Configurable general purpose I/O pin/BUZZER CMOS 2.8V

3) Antenna Connectors

The Telit GM862-GPS includes two 50 Ohm MMCX coaxial female RF connectors.

On the user application side the following connector must be used.

GPS Antenna Requirements

Frequency range 1575.42 MHz (GPS L1) Bandwidth +/−1.023 MHz Gain 1.5 dBi<Gain<4.5 dBi Impedance 50 ohm Amplification Typical 25 dB (max 27 dB) supply voltage Must accept from 3 to 5 V DC Current consumption Typical 20 mA (40 mA max).

Where not specifically stated, all the interface circuits work at 2.8V CMOS logic levels.

Input level on any digital pin when on −0.3V+3.6V

Input voltage on analog pins when on −0.3V+3.0 V

Voltage on Buffered pins −0.3V 25V

Operating Range—Interface levels (2.8V CMOS)

Level Min-Max

Input high level 2.1V 3.3V

Input low level 0V 0.5V

Output high level 2.2V 3.0V

Output low level 0V 0.35V

For 2.0V signals:

Operating Range—Interface levels (2.0V CMOS)

Level Min-Max

Input high level 1.6V 3.3V

Input low level 0V 0.4V

Output high level 1.65V 2.2V

Output low level 0V 0.35V

Power Supply:

Nominal Supply Voltage 3.8 V; Max Supply Voltage 4.2 V; Supply voltage range 3.4 V-4.2 V.

Power saving: CFUN=0 module registered on the network and can receive voice call or an SMS; but it is not possible to send AT commands; module wakes up with an unsolicited code (call or SMS) or rising RTS line. CFUN=5 full functionality with power saving; module registered on the network can receive incoming calls and SMS IDLE mode with GPS ON3 full power mode AT+CFUN=1 113.0 Stand by mode; no call in progress; GPS ON AT+CFUN=4 111.0 IDLE mode with GPS ON trickle power mode, standby mode; no call in progress; GPS consumption reduced AT+CFUN=1 64.0 maintaining the NMEA sentences AT+CFUN=4 62.0 IDLE mode with GPS ON push to fix mode Stand by mode; no call in progress; GPS performs a fix and then it switches off for the defined period AT+CFUN=1 24.0; AT+CFUN=4 22.0; AT+CFUN=5 10.0

RX mode—GSM Receiving data mode

1 slot in downlink 53.0; 2 slot in downlink 65.0; 3 slot in downlink 78.0; 4 slot in downlink 91.0

GSM TX and RX mode GPS ON

Min power level 135.0 GSM Sending data mode; Max power level 254.0

GPRS (class 10) TX and RX mode GPS ON

Min power level 187.0 GPRS Sending data mode; Max power level 430.0

GM862-GPS (3 990 250 657), GM862-GPS (3 990 250 689)

Operating current 70 mA±20%, including 50 mA for the GPS hardware and 20 mA for the antenna LNA 55 mA, including 35 mA GPS for the GPS hardware and 20 mA for the antenna LNA

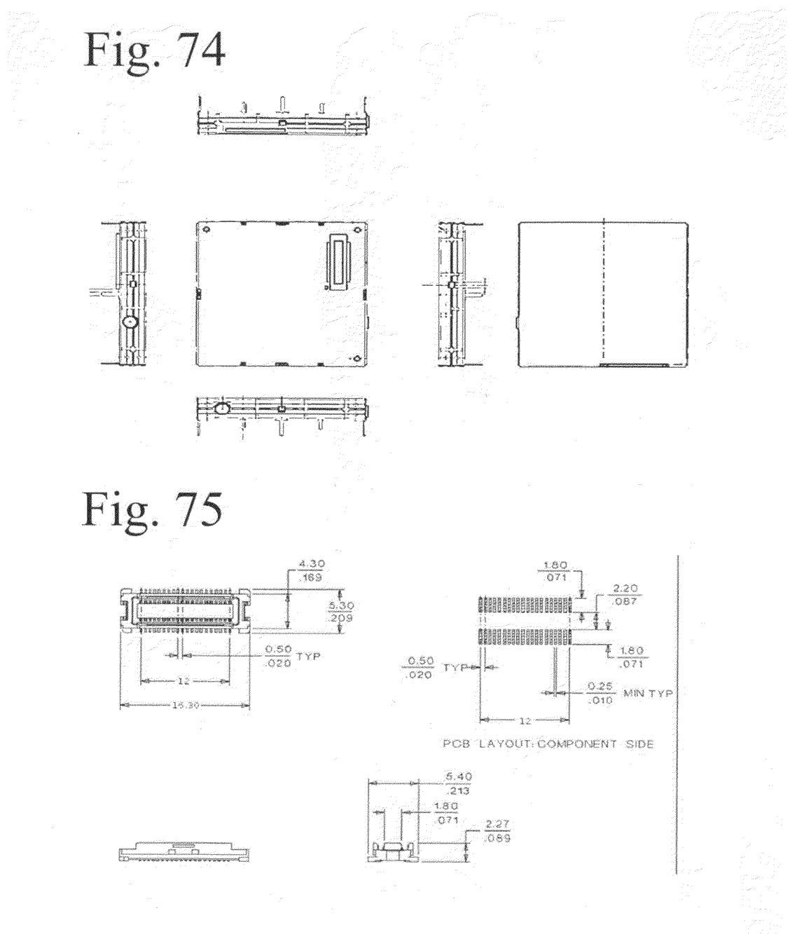

See FIG. 74. The GSM system is made in a way that the RF transmission is not continuous, else it is packed into bursts at a base frequency of about 216 Hz and the relative current peaks can be as high as about 2A. Therefore the power supply has to be designed in order to withstand with these current peaks without big voltage drops; this means that both the electrical design and the board layout must be designed for this current flow. If the layout of the PCB is not well designed a strong noise floor is generated on the ground and the supply; this will reflect on all the audio paths producing an audible annoying noise at 216 Hz; if the voltage drop during the peak current absorption is too much, then the device may even shutdown as a consequence of the supply voltage drop. See FIG. 75.

### Board to Board Connector

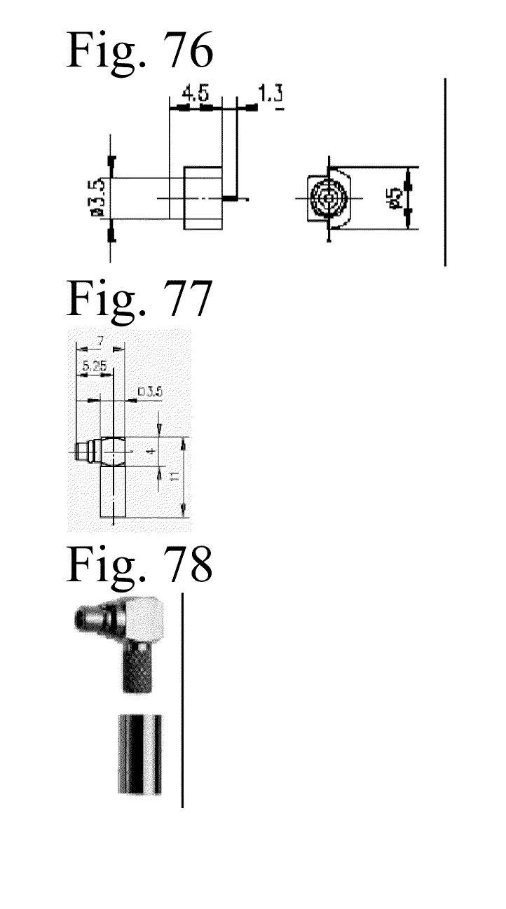

Molex 52991-0508 (male) GM862 Connector layout and Antenna Connectors (See FIGS. 76-78)

### Turning ON the GM862-GPS

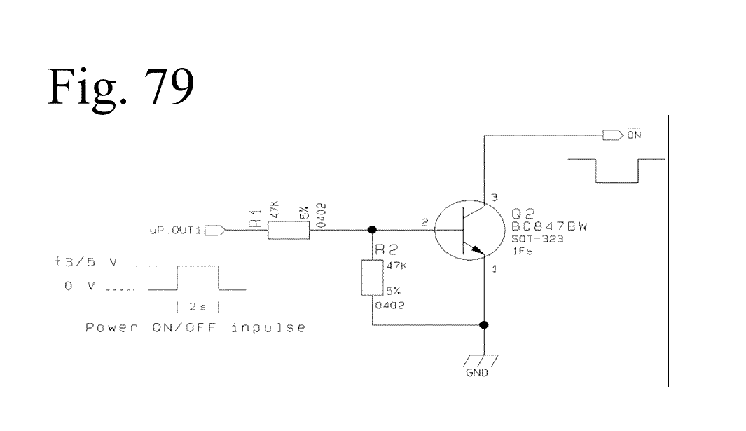

To turn on the GM862-GPS the pin ON# must be tied low for at least 1 second and then released. The maximum current that can be drained from the ON# pin is 0.1 mA. A simple circuit to do this is as follows: (See FIG. 79)

B. Microcontroller

### Description:

In order for our devices (sensors, GPRS . . . ) to communicate correctly an Analog/Digital Signal Controller also known as Microcontroller is needed. For the bracelet the 56F8023 16-bit Microcontroller will be used, this specified microcontroller is manufactured by “freescale Semiconductor”.

The 56F8023 is a member of the 56800E core-based family of Digital Signal Controllers (DSCs). when compared to other products the 56F8023 combines, on a single chip, the processing power of a DSP and the functionality of a microcontroller with a flexible set of peripherals to create an extremely cost-effective solution. Because of its low cost, small size, configuration flexibility, and compact program code, the 56F8023 is well-suited for the bracelet design. The 56F8023 includes many peripherals that are especially useful for industrial smart sensors applications.
1. Overview of the 56F8023:
   Digital Signal Controller Core
      Efficient 16-bit 56800E family Digital Signal Controller (DSC) engine with dual Harvard architecture
      As many as 32 Million Instructions per second (MIPS) at 32 MHz core frequency
      Single-cycle 16×16-bit parallel Multiplier-Accumulator (MAC)
      Four 36-bit accumulators, including extension bits
      32-bit arithmetic and logic multi-bit shifter
      Parallel instruction set with unique DSP addressing modes
      Hardware DO and REP loops
      Three internal address buses
      Four internal data buses
      Instruction set supports both DSP and controller functions
      Controller-style addressing modes and instructions for compact code
      Efficient C compiler and local variable support
      Software subroutine and interrupt stack with depth limited only by memory
      JTAG/Enhanced On-Chip Emulation (OnCE) for unobtrusive, processor speed-independent, real-time debugging
   Memory
      Dual Harvard architecture permits as many as three simultaneous accesses to program and data memory
      Flash security and protection that prevent unauthorized users from gaining access to the internal Flash
      On-chip memory
         32 KB of Program Flash
         4 KB of Unified Data/Program RAM
      EEPROM emulation capability using Flash
   Energy Information
      Fabricated in high-density CMOS with 5V tolerance
      On-chip regulators for digital and analog circuitry to lower cost and reduce noise
      Wait and Stop modes available
      ADC smart power management
      Each peripheral can be individually disabled to save power

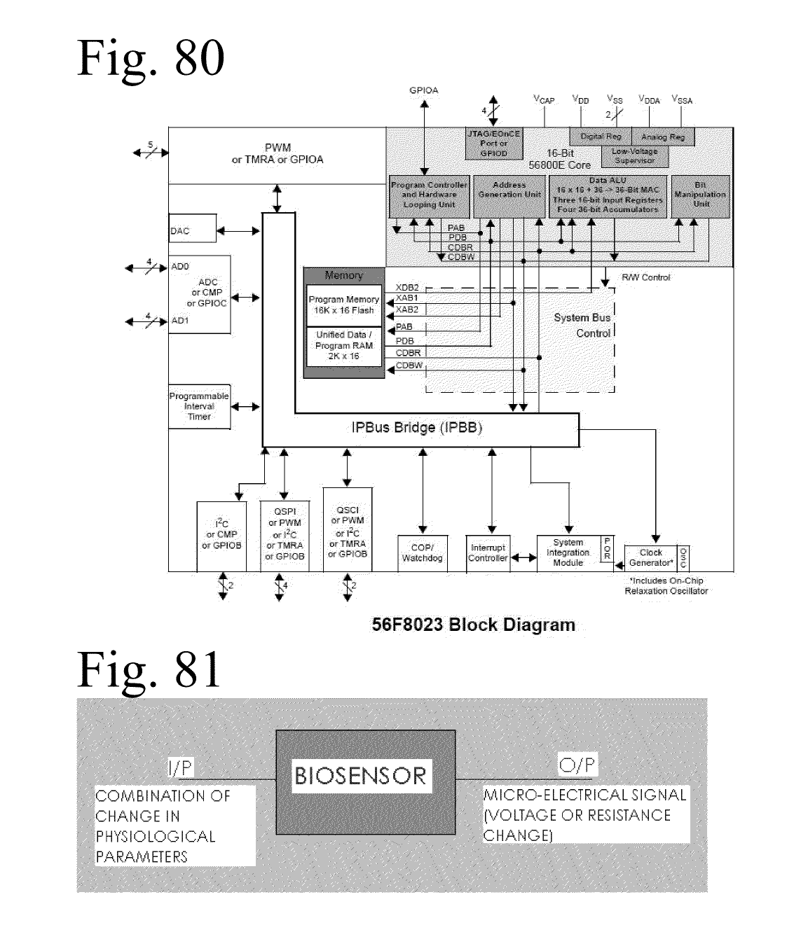

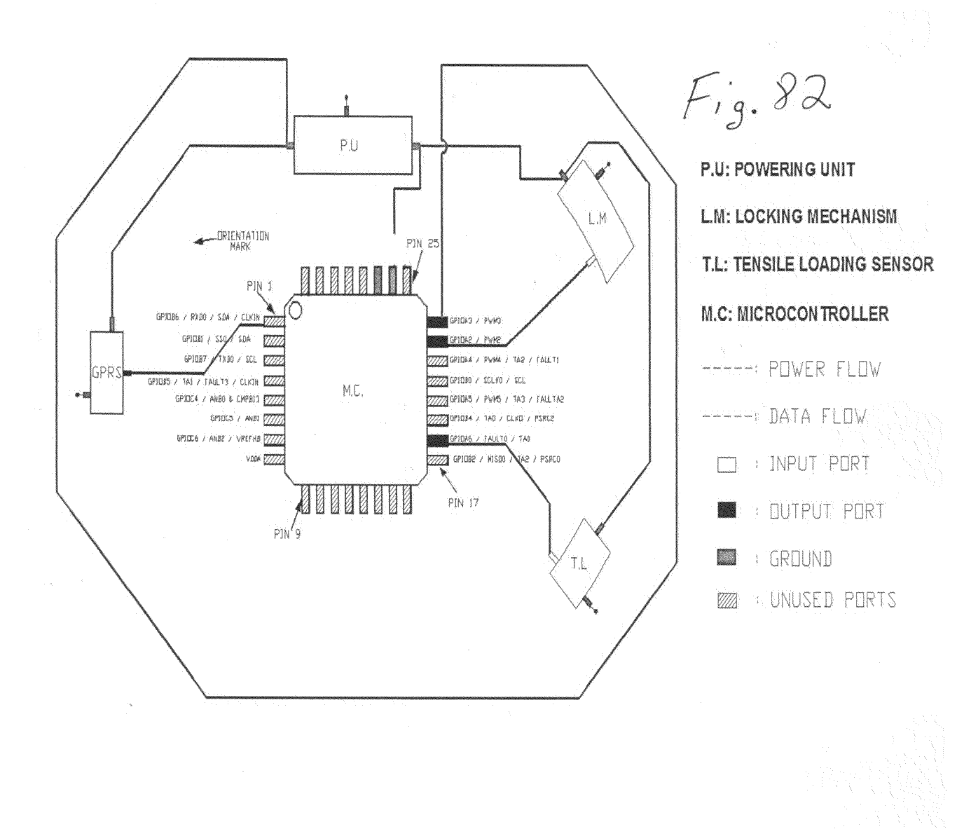

### 56F8023 Block Diagram (See FIG. 80)

2. Signal/Connection Descriptions:

TABLE 2-1
Functional Group Pin Allocations

| Functional Group | Number of Pins |
|---|---|
| Power Inputs (V_{DD}, V_{DDA}) | 2 |
| Ground (V_{SS}, V_{SSA}) | 3 |
| Supply Capacitors | 1 |
| Reset¹ | 1 |
| Pulse Width Modulator (PWM) Ports¹ | 11 |
| Serial Peripheral Interface (SPI) Ports¹ | 4 |
| Timer Module A (TMRA) Ports¹ | 4 |
| Analog-to-Digital Converter (ADC) Ports¹ | 6 |
| Serial Communications Interface 0 (SCI0) Ports¹ | 2 |
| Inter-Integrated Circuit Interface (I²C) Ports¹ | 2 |
| JTAG/Enhanced On-Chip Emulation (EOnCE¹) | 4 |

The input and output signals of the 56F8023 are organized into functional groups, as detailed in Table 2-1.
3. General-Purpose Input/Output (GPIO):

There are four GPIO ports defined on the 56F8023. The width of each port, the associated peripheral and reset functions are shown in Table 3-1

TABLE 3-1
GPIO Ports Configuration

| | Available | | |
|---|---|---|---|
| GPIO | Pins in | | |
| Port | 56F8023 | Peripheral Function | Reset Function |
| A | 8 | PWM, Timer, QSPI, | GPIO, R̅E̅S̅E̅T̅ |
| | | Comparator, Reset | |
| B | 8 | QSPI, I²C, PWM, Clock, | GPIO |
| | | Comparator, Timer | |
| C | 6 | ADC, Comparator, QSCI | GPIO |
| D | 4 | Clock, Oscillator, JTAG | GPIO, JTAG |

The GPOI are ports used by the 53F8023 to receive and send data, locating them and know each one of them is critical. The specific mapping of GPIO port pins on the actual ship is shown in Table 3-2.

TABLE 3-2
GPIO External Signals Map

| | | LQFP | |
|---|---|---|---|
| GPIO Function | Peripheral Function | Package Pin | Notes |
| [symbol] PIOA0 | PWM0 | 29 | Defaults to A0 |
| [symbol] PIOA1 | PWM1 | 28 | Defaults to A1 |
| [symbol] PIOA2 | PWM2 | 23 | Defaults to A2 |
| [symbol] PIOA3 | PWM3 | 24 | Defaults to A3 |
| [symbol] PIOA4 | PWM4/TA2/FAULT1 | 22 | SIM register SIM_GPS is used to |
| | | | select between PWM4, TA2, and |
| | | | FAULT1, |
| | | | Defaults to A4 |
| [symbol] PIOA5 | PWM5/TA3/FAULT2 | 20 | SIM register SIM_GPS is used to |
| | | | select between PWM5, TA3, and |
| | | | FAULT2, |
| | | | Defaults to A5 |
| [symbol] PIOA6 | FAULT0/TA0 | 18 | SIM register SIM_GPS is used to |
| | | | select between FAULT0 and TA0. |
| | | | Defaults to A6 |
| [symbol] PIOA7 | R̅E̅S̅E̅T̅ | 15 | Defaults to R̅E̅S̅E̅T̅ |
| [symbol] PIOB0 | SCLK0/SCL | 21 | SIM register SIM_GPS is used to |
| | | | select between SCLK and SCL. |
| | | | Defaults to B0 |
| [symbol] PIOB1 | S̅S̅0̅/SDA | 2 | SIM register SIM_GPS is used to |
| | | | select between S̅S̅0̅ and SDA. |
| | | | Defaults to B1 |
| [symbol] PIOB2 | MISO0/TA2/PSRC0 | 17 | SIM register SIM_GPS is used to |
| | | | select between MISO0, TA2, and |
| | | | PSRC0. |
| | | | Defaults to B2 |
| [symbol] PIOB3 | MOSI0/TA3/PSRC1 | 16 | SIM register SIM_GPS is used to |
| | | | select between MOSI0, TA3 and |
| | | | PSRC1. |
| | | | Defaults to B3 |
| [symbol] PIOB4 | TA0/CLKO/PSRC2 | 38 | SIM register SIM_GPS is used to |
| | | | select between TA0, CLKO, and |
| | | | [symbol] |
| GPIOB5 | TA1/FAULT3/CLKIN | 4 | SIM register SIM_GPS is used to |
| | | | select between TA1, FAULT3, and |
| | | | CLKIN. |
| | | | CLKIN functionality is enabled using |
| | | | the PLL Control Register within the |
| | | | OCCS block. |
| | | | Defaults to B5 |
| GPIOB6 | RXD0/SDA/CLKIN | 1 | SIM register SIM_GPS is used to |
| | | | select between RXD0, SDA, and |
| | | | CLKIN. |
| | | | CLKIN functionality is enabled using |
| | | | the PLL Control Register within the |
| | | | OCCS block. |
| | | | Defaults to B6 |
| GPIOB7 | TXD0/SCL | 3 | SIM register SIM_GPS is used to |
| | | | select between TXD0 and SCL. |
| | | | Defaults to B7 |
| GPIOC0 | ANA0 & CMPAI3 | 12 | Defaults to C0 |
| GPIOC1 | ANA1 | 11 | Defaults to C1 |
| GPIOC2 | ANA2/V_{REFHA} | 10 | SIM register SIM_GPS is used to |
| | | | select between ANA2 and V_{REFHA}. |
| | | | Defaults to C2 |
| GPIOC4 | ANB0/CMPBI3 | 5 | SIM register SIM_GPS is used to |
| | | | select between ANB0 and CMPBI3. |
| | | | Defaults to C4 |
| GPIOC5 | ANB1 | 6 | Defaults to C5 |
| GPIOC6 | ANB2/V_{REFHA} | 7 | SIM register SIM_GPS is used to |
| | | | select between ANB2 and V_{REFHA}. |
| | | | Defaults to C6 |
| GPIOD0 | TDI | 30 | Defaults to TDI |
| GPIOD1 | TDO | 32 | Defaults to TDO |
| GPIOD2 | TCK | 14 | Defaults to TCK |
| [symbol] | [symbol] | [symbol] | [symbol] |

[symbol]

indicates data missing or illegible when filed

The 56F8023 is fabricated in high-density CMOS with 5V-tolerant TTL-compatible digital inputs. The term “5V-tolerant” refers to the capability of an I/O pin, built on a 3.3V-compatible process technology, to withstand a voltage up to 5.5V without damaging the device. Many systems have a mixture of devices designed for 3.3V and 5V power supplies. In such systems, a bus may carry both 3.3V- and 5V-compatible. I/O voltage levels (a standard 3.3V I/O is designed to receive a maximum voltage of 3.3V±10% during normal operation without causing damage). This 5V-tolerant capability therefore offers the power savings of 3.3V I/O levels, combined with the ability to receive 5V levels without damage. Absolute maximum ratings in Table 4-1 are stress ratings only, and functional operation at the maximum is not

TABLE 4-1
Absolute Maximum Ratings
(V_{SS} = 0V. V_{SSA} = 0V)

| Characteristic | Symbol | Notes | Min | Max | Unit |
|---|---|---|---|---|---|
| Supply Voltage Range | V_{DD} | | −0.3 | 4.0 | V |
| Analog Supply Voltage Range | V_{DDA} | | −0.3 | 4.0 | V |
| ADC High Voltage Reference | V_{REFHx} | | −0.3 | 4.0 | V |
| Voltage difference V_{DD} to V_{DDA} | ΔV_{DD} | | −0.3 | 0.3 | V |
| Voltage difference V_{SS} to V_{SSA} | ΔV_{SS} | | −0.3 | 0.3 | V |
| Digital Input Voltage Range | V_{IN} | Pin Groups 1, 2 | −0.3 | 6.0 | V |
| Oscillator Voltage Range | V_{OSC} | Pin Group 4 | −0.4 | 4.0 | V |
| Analog Input Voltage Range | V_{INA} | Pin Group 3 | −0.3 | 4.0 | V |
| Input clamp current. per pin (V_{IN} < 0)¹ | V_{IC} | | — | −20.0 | mA |
| Output clamp current, per pin (V_{O} < 0)¹ | V_{OC} | | — | −20.0 | mA |
| Output Voltage Range | V_{OUT} | Pin Group 1 | −0.3 | 4.0 | V |
| (Normal Push-Pull mode) | | | | | |
| Output Voltage Range | V_{OUTOD} | Pin Group 2 | −0.3 | 6.0 | V |
| (Open Drain mode) | | | | | |
| Ambient Temperature | T_{A} | | −40 | 105 | ° C. |
| Industrial | | | | | |
| Storage Temperature Range | T_{STG} | | −55 | 150 | ° C. |
| (Extended Industrial) | | | | | |

¹Continuous clamp current per pin is −2.0 mA

guaranteed. Stress beyond these ratings may affect device reliability or cause permanent damage to the device.
5. Packaging:

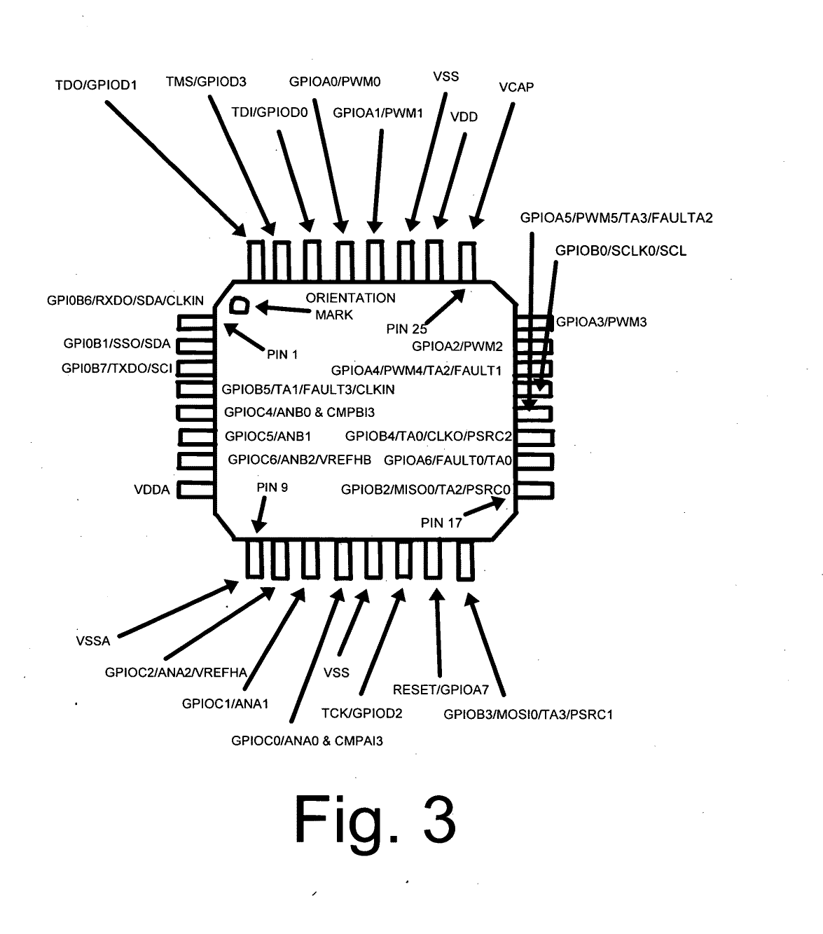

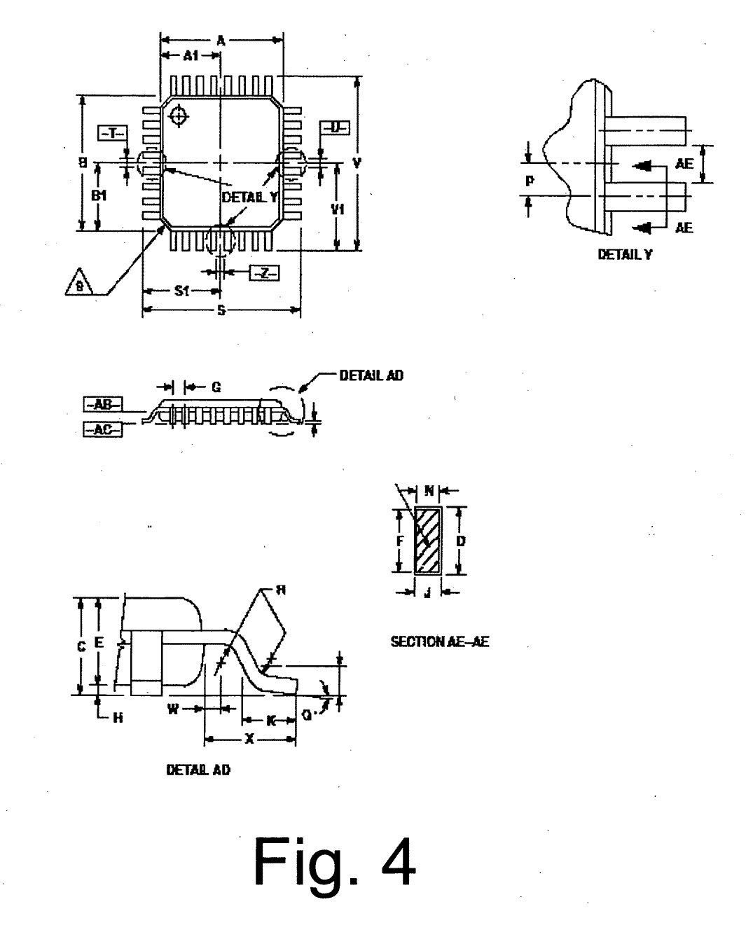

This section contains package and pin-out information for the 56F8023. This device comes in a 32-pin Low-profile Quad Flat Pack (LQFP). FIG. 3 shows the package outline, FIG. 4 shows the mechanical parameters and Table 5-1 lists the pin-out.
a) 56F8023 Package and Pin-Out Information
b) LQFP Package Identification by Pin Number

TABLE 5-1
56F8023 32-Pin LQFP Package Identification by Pin Number¹

| Pin # | Signal Name |
|---|---|
| 1 | GPIOB6 |
| | RXD0/SDA/CLKIN |
| 2 | GPIOB1 |
| | S̅S̅0̅/SDA |
| 3 | GPIOB7 |
| | TXD0/SCL |
| 4 | GPIOB5 |
| | TA1/FAULT3/CLKIN |
| 5 | GPIOC4 |
| | ANB0 & CMPBI3 |
| 6 | GPIOC5 |
| | ANB1 |
| 7 | GPIOC6 |
| | ANB2/V_{REFHB} |
| 8 | V_{DDA} |
| 9 | V_{SSA} |
| 10 | GPIOC2 |
| | ANA2/V_{REFHA} |
| 11 | GPIOC1 |
| | ANA1 |
| 12 | GPIOC0 |
| | ANA0 & CMPAI3 |
| 13 | V_{SS} |
| 14 | TCI |
| | GPIOD2 |
| 15 | R̅E̅S̅E̅T̅ |
| | GPIOA7 |
| 16 | GPIOB3 |
| | MOSI0/TA3/ |
| | PSRC1 |
| 17 | GPIOB2 |
| | MISO0/TA2/PSRC0 |
| 18 | GPIOA6 |
| | FAULT0/TA0 |
| 19 | GPIOB4 |
| | TA0/CLKO/PSRC2 |
| 20 | GPIOA5 |
| | PWM5/TA3/FAULT2 |
| 21 | GPIOB0 |
| | SCLK0/SCL |
| 22 | GPIOA4 |
| | PWM4/TA2/FAULT1 |
| 23 | GPIOA2 |
| | PWM2 |
| 24 | GPIOA3 |
| | PWM3 |
| 25 | V_{CAP} |
| 26 | V_{DD} |
| 27 | V_{SS} |
| 28 | GPIOA1 |
| | PWMI |
| 29 | GPIOA0 |
| | PWM0 |
| 30 | TDI |
| | GPIOD0 |
| 31 | TMS |
| | GPIOD3 |
| 32 | TDO |
| | GPIOD1 |

¹Alternate signals are in italic

c) LQFP Mechanical Information
d) Summary:

Table 6-1 outlines the most impotent features of the 56F8023 Microcontroller

TABLE 6-1
56F8023 Ordering Information

| | | | | | Ambient | Budgetary Price |
|---|---|---|---|---|---|---|
| | Supply | | Pin | Frequency | Temperature | QTY 1000+ |
| Device | Voltage | Package Type | Count | (MHz) | Range | ($US) |
| MC56F8023 | 3.0-3.6 V | Low-Profile Quad | 2 | 32 | −40° C. to +105° C. | 3.30 |
| | | Flat Pack (LQFP) | | | | |

C. Powering Units

D. Bio-Sensing

### Biosensors:

Even though inclusion of GPS, GPRS tracking, feedback (alarm sending), and tamper proof locking mechanism in this design assures improved safety of a child than any other existing conventional child protection system, use of biosensors in the device to measure the fear in real time as a child experiences a life threatening situation provides the additional safety and protection that can not only reduce the number of child abduction cases, but also reduce many crimes and criminal attempts against children.

Biosensor is a sensing device that measures some key decisive physiological signs of fear in a human body and provides micro-electrical signal as an output that can be easily digitalized using an AD (analog to digital) converter and transmitted through a GPRS/GPS system to a data receiving location for recording and informing law enforcement agencies regarding a possible life threatening situation for a child. The difficulty in the design of biosensor lies in the precise measurement of fear using the currently marketed (Biosensors) physiological variations measurement devices. In order to form an unbreakable and tamper proof child protection system, it is necessary to understand fear, the constituents of fear and how the fear is measured.

### Fear:

Emotions play an important part in our daily lives. Fear is one such emotion that is pre-programmed into all people as an instinctual response to potential danger. As for what is fear biologically speaking, when a person experiences fear, certain areas in their brain such as the amygdale and the hypothalamus are immediately activated and appear to control the first physical response to fear. Chemicals such as adrenaline and the stress hormone cortisols are released into the blood stream causing certain physical reactions such as:

Rapid heart rate

Increased blood pressure

Tightening of muscles and constriction of some vanes

Sharpened or redirected senses

Dilation of the pupils (to allow more light passage)

Increased sweating

There are other significant changes in the human physiological parameters that offer a much higher probability of measuring fear. The following is the list of some of the essential changes that are measured and tested for many general and operational medical procedures:

Change in oxygen level in the blood stream

Change in electrical activity of the brain and heart

Generation of P-300 waves due to the occurrence of surprise crucial

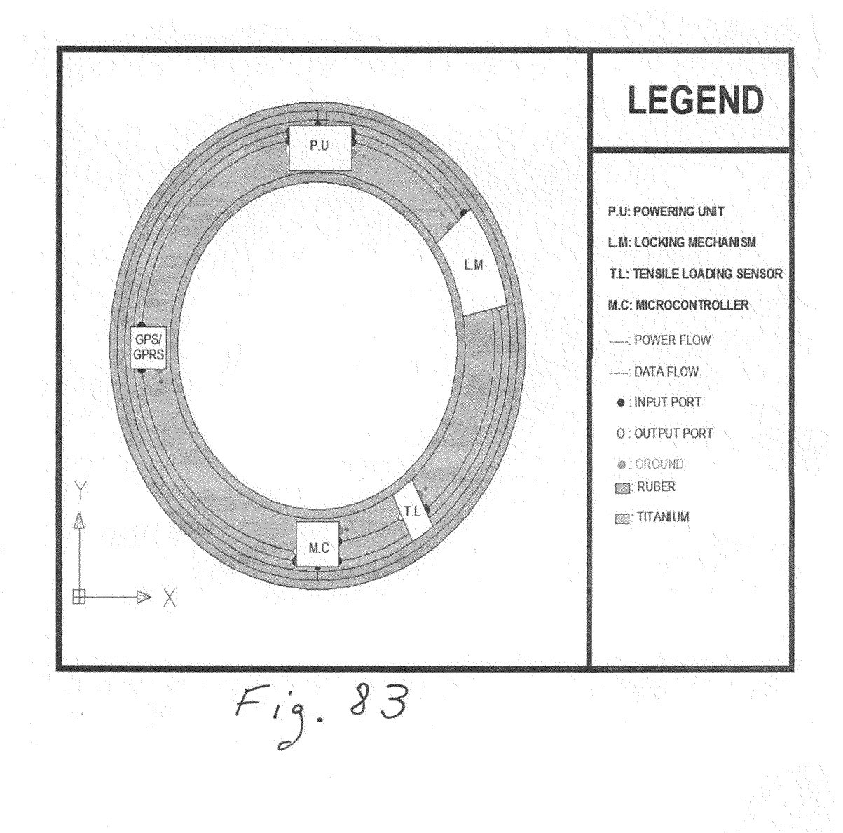

The measurement of the change in oxygen level and specific electrical activity of the brain and the heart can be related to the occurrence of fear only and not any other emotion. This design (device) uses a biosensor that measures the electrical activity of the brain and the heart using ECG and EEG sensor electrodes. The measured electrical activity change of the heart and the brain is digitalized and amplified using a microcontroller and then the digital signal is authenticated using a program also loaded on to the microcontroller. The authentication process confirms the validity and percentage of fear to activate the Biosensor and GPR/GPS. See FIG. 81.

V System Integration and Operation

A. Principle of Alarm System Operation:

Keeping in mind the possibility of children playing with a panic button thereby resulting in increase in the false panic alarms, we have designed a panic alarm system which is activated only in case of tampering with the bracelet device. In this design three types of tampering are considered. If the bracelet device is tried to get rid off by forcefully pulling from the wrist, tensile loading sensors will be activated, where slight change in the resistance is sensed by change in voltage. This change in voltage generates an electric current that is fed to the microcontroller to produce digital output. This digital output as a positive alarm signal is sent through the GPRS chip to the monitoring center.

In the second case, if anyone tries to cut the bracelet around its circumference, he/she will cut one of the wires that are webbed and embedded in the rubber casing around the actual titanium bracelet. Cutting of one of these wires stops the current flow through the wire webbing; thereby sending positive alarm signal logic to the GPRS chip through the microcontroller.

In the third case, if anyone tries to tamper with the locking mechanism a similar electric signal is generated to send positive alarm signal logic to the GPRS chip through the microcontroller.

Before the positive alarm signal is read by GPRS chip, it goes through an Analog to Digital Converter Module (Microcontroller), which changes this electrical signal into a digital signal. Once positive digitalized alarm signal is read by the GPRS chip, it sends out a digital alarm signal on a set radio frequency which is pre-assigned for this application or for this chip. Then the 32 satellites orbiting around the planet will pick up these signals and release them back into the earth's atmosphere on a pre-assigned radio frequency in the form of a Pseudo-Random Code along with some specific identification code of the GPRS chip the signal was sent from.

At the monitoring location, there are radio receivers tuned into those set frequencies. When the alarm signal is transmitted through satellites, these radio receivers will immediately pick them up. Then at monitoring location, decoders are used to decode the Pseudo-Random Code sent by the satellite to find out the exact identification number of the GPRS chip it was sent from. Since initially all the information about the users along with these identification have been saved in the monitoring agencies data base, it will be easier to track down the device using real time tracking technique and the GPS chip fitted into that specific user's bracelet.

The real time tracking information can be sent to the law enforcement authorities to help them trace the subject.

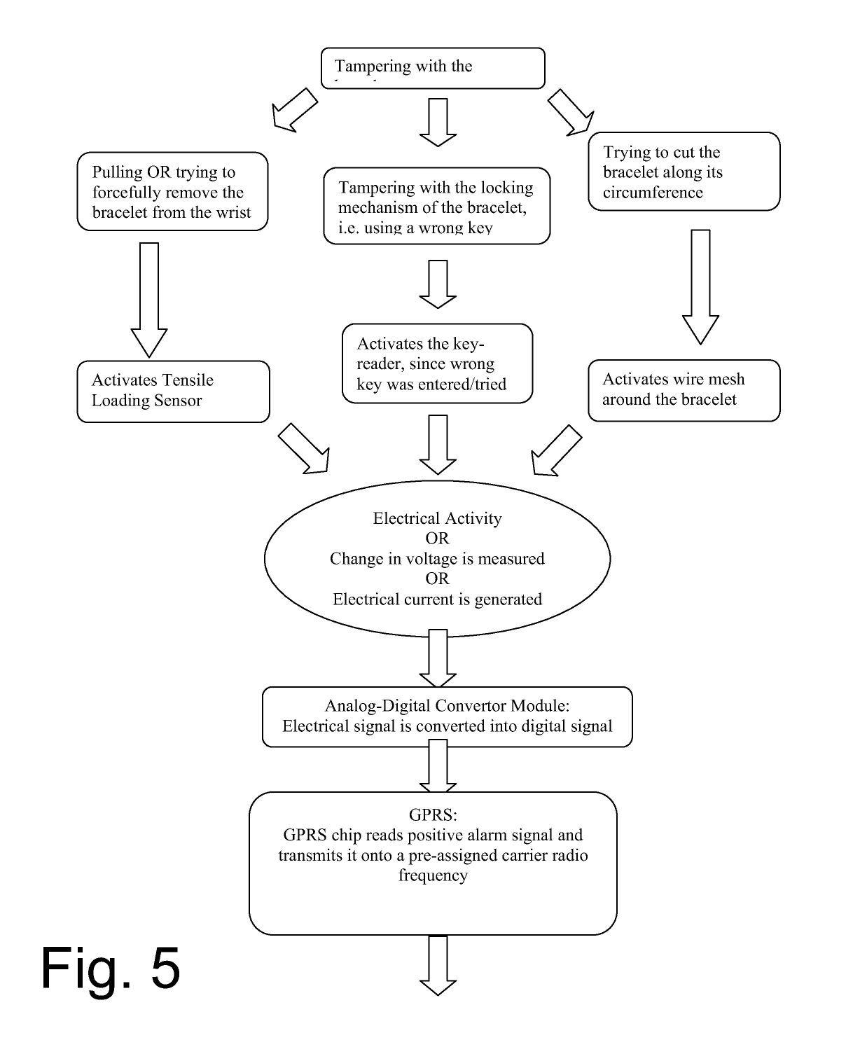

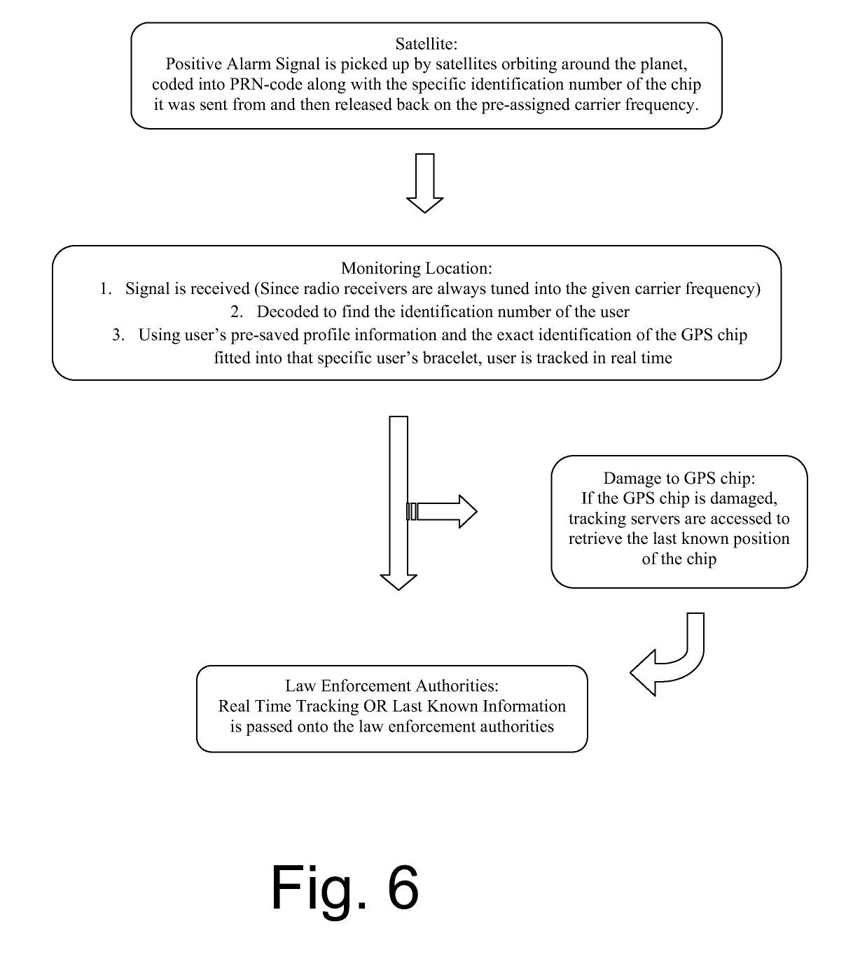

B. Data Flow Diagram: See FIGS. 5 and 6.

C. System Integration Schematic. See FIG. 82.

D. Cross-Section Along the Circumference (See FIG. 83)

VI Data Management

The device will need to have the ability to receive and send data

### Data Received:

In case of someone trying to cut or open the bracelet by applying force to it

In case of someone using the wrong key to open the bracelet

In case of elevated fear signals.

in all this cases the bracelet will be receiving critical data from the outside world and the bracelet will have to translate that data and either find it alarming or negligible.

### Data Sent:

GPS signal to be sent 24/7.

A silent alarm response after one of the three cases above is present.

All the data will be transmitted directly to the monitoring servers. the servers are branched to two kinds:

First type receives information from the GPS and records the movement 24/7 and also makes the info available to the users (in this case the parents) at any given time of the day.

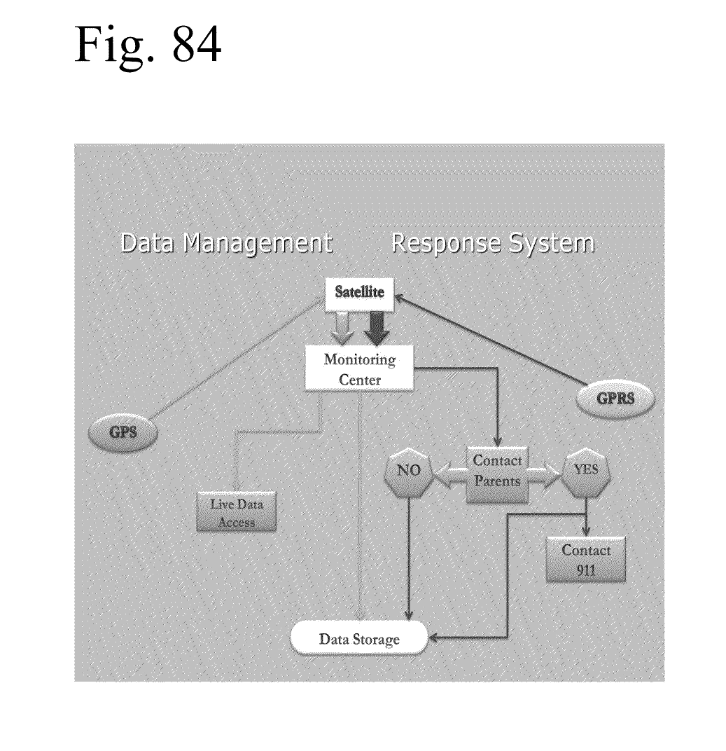

Second type receives the data sent by the silent alarm system and gets the exact location and information where the alarm originates from (info being the kids ID) then brings up the mater on either agents screen or directly on police channels (as an electronic 911) (See FIG. 84)

VII Cost Analysis

Electronic Hardware

| | |
|---|---|
| GPS CHIP | $40/per 1 unit |
| | $25/per 1000 units |
| GPRS CHIP | $80/per 1 unit |
| | $40/per 1000 units |

Materials

| | |
|---|---|
| Titanium | $200/lb |
| Rubber Compound | $50/lb |
| Copper wire | $20/lb |
| Locking Mechanism | $20/per unit |
| | $10/per 1000 units |

Cost

| | |
|---|---|
| Cost for a unit | $130 |
| Cost for 1000 units | $80 |

List of Materials:

| | | | Est. |
|---|---|---|---|
| Items | Manufacturers | Sizes (mm) | Price ($) |
| GPS chip | SIRF, SUNROM | 4 × 4 × 1.5 | 100.00 |
| GPRS/GSM chip | Sulekha B2B, | 10 × 10 × 3 | 100.00 |
| | Electron, Inc. | | |
| GPS Tracking | VTec Electronic | 8 × 8 × 3 | 100.00 |
| Biosensors (Photrodes) | Srico, Inc. | 10 × 10 × 5 | 500.00 |
| A/D Converter | National | 10 × 10 × 5 | 50.00 |
| | Semiconductor | | |
| Body & Locking M | ABC | XYZ | 3000.00 |
| Powering Devices | A123, Inc. | Custom | 500.00 |
| Miscellaneous | ABC | XYZ | 1000.00 |
| Expediting Cost | | | 500.00 |
| Supporting Elements | | | 1500.00 |
| Taxes | | | 450.00 |
| Estimated Total | | | 7800.00 |

Heart Beat Sensor Price: $33.33

This heart beat sensor is designed to give digital output of heat beat when a finger is placed inside it. When the heart detector is working, the top-most LED flashes in unison with each heart beat. This digital output can be connected to microcontroller directly to measure the Beats Per Minute (BPM) rate. It works on the principle of light modulation by blood flow through finger at each pulse. For further information please refer to its datasheet.

It should be understood that the present invention is at least the following:

A system for personal security, comprising embedding a tracking device and transmitter into a personal accessory; emitting an alert when the personal accessory is activated; transmitting the alert when there is an attempt to remove the personal accessory; receiving the alert via an authorized receiver; permitting only the authorized receiver to cancel the alert. The system further comprising saving dynamic memory at an authorized receiver such that a location of the personal accessory can be tracked after the alert is emitted. The system for personal security further comprising permitting the authorized receiver to be a central receiving location. The system for personal security further comprising transmitting a special and unique message in conjunction with a specific scenario. The system for personal security further comprising sending the alert in case of tampering with the personal accessory. The system for personal security further comprising transmitting the location of the personal accessory first in case of tampering with the personal accessory. The system for personal security further comprising providing a safety locking mechanism to prevent a person from removing the personal accessory without approval of the authorized receiver. The system for personal security further comprising transmitting the alert after detecting dramatic changes in oxygen levels in a blood stream through sensors located within the personal accessory.

I claim:

1. A system for personal security, comprising:
embedding a tracking device and transmitter into a personal accessory;
emitting an alert when the personal accessory is activated;
transmitting the alert when there is an attempt to remove the personal accessory;
receiving the alert via an authorized receiver;
permitting only the authorized receiver to cancel the alert.

2. The system for personal security of claim 1, further comprising saving dynamic memory at an authorized receiver such that a location of the personal accessory can be tracked after the alert is emitted.

3. The system for personal security of claim 2, further comprising permitting the authorized receiver to be a central receiving location.

4. The system for personal security of claim 1, further comprising transmitting a special and unique message in conjunction with a specific scenario.

5. The system for personal security of claim 1, further comprising sending the alert in case of tampering with the personal accessory.

6. The system for personal security of claim 5, further comprising transmitting the location of the personal accessory first in case of tampering with the personal accessory.

7. The system for personal security of claim 1, further comprising providing a safety locking mechanism to prevent a person from removing the personal accessory without approval of the authorized receiver.

8. The system for personal security of claim 1, further comprising transmitting the alert after detecting dramatic changes in oxygen levels in a blood stream through sensors located within the personal accessory.
